(19) United States
(12) Patent Application Publication
(10) Pub. No.: US 2026/0358919 A1
(43) Pub. Date: Nov. 12, 2026

(54) ELECTRONIC DEVICE AND METHOD OF DRIVING SAME

(71) Applicant: Samsung Display Co, Ltd., Yongin-si (KR)

(72) Inventors: Jaehyun PARK, Yongin-si (KR); Dongwan CHOI, Yongin-si (KR)

(73) Assignee: Samsung Display Co, Ltd., Yongin-si (KR)

(21) Appl. No.: 19/421,549

(22) Filed: Dec. 16, 2025

(30) Foreign Application Priority Data
May 9, 2025 (KR) 10-2025-0060567

(51) Int. Cl. G06F 3/041; G06F 3/044

(52) U.S. Cl. CPC G06F 3/041662; G06F 3/0412; G06F 3/0443; G06F 3/0446; G06F 2203/04106; G06F 2203/04111; G06F 2203/04112

(57) ABSTRACT

An electronic device includes a display layer, a sensor layer on the display layer and including a plurality of sensing electrodes in an active area, a sensor driver configured to drive the sensor layer in each sensing frame, and a multiplexer connected between the sensor layer and the sensor driver. The plurality of sensing electrodes includes first sensing electrodes and second sensing electrodes. The multiplexer includes a first multiplexer connected to at least two first sensing electrodes among the plurality of first sensing electrodes, and a second multiplexer connected to at least two second sensing electrodes among the plurality of second sensing electrodes, and the sensor driver is configured to provide a driving signal simultaneously to the at least two first sensing electrodes.

### CROSS-REFERENCE TO RELATED APPLICATIONS

This application claims priority under 35 U.S.C. § 119 to and the benefit of Korean Patent Application No. 10-2025-0060567 filed on May 9, 2025, in the Korean Intellectual Property Office, the disclosure of which is incorporated by reference herein in its entireties.

### BACKGROUND

Embodiments of the disclosure relate to an electronic device with improved reliability and a method of driving the electronic device.

An electronic device includes a display layer, which displays an image, a display driver, which transmits a signal to the display layer, a sensor layer disposed on the display layer, and a sensor driver, which transmits a driving signal to the sensor layer.

The sensor layer which is a type of information input device may be provided and used in the electronic device. For an example, the sensor layer may be attached on one surface of the display layer or may be integrally formed with the display layer. The user may input information by pressing or touching the sensor layer while viewing an image displayed on a screen of the electronic device.

### SUMMARY

Embodiments of the disclosure provide an electronic device capable of improving reliability and a method of driving the electronic device.

According to an embodiment, an electronic device may include a display layer, a sensor layer on the display layer and including a plurality of sensing electrodes in an active area, a sensor driver that drives the sensor layer in each sensing frame, and a multiplexer connected between the sensor layer and the sensor driver. The plurality of sensing electrodes may include a plurality of first sensing electrodes each extending in a first direction, and a plurality of second sensing electrodes each extending in a second direction intersecting the first direction. The multiplexer may include a first multiplexer connected to at least two first sensing electrodes among the plurality of first sensing electrodes, and a second multiplexer connected to at least two second sensing electrodes among the plurality of second sensing electrodes, and the sensor driver may be configured to provide a driving signal simultaneously to the at least two first sensing electrodes.

The sensing frame may include a first sensing period in which an external input is sensed based on the plurality of first sensing electrodes, a second sensing period in which the external input is sensed based on the plurality of second sensing electrodes, and a third sensing period in which the driving signal is output.

The sensor layer may be configured to operate in a self-capacitance manner in the first sensing period and the second sensing period, and the sensor layer may be configured to operate in a mutual-capacitance manner in the third sensing period.

In the third sensing period, the sensor driver may be configured to receive a sensing signal corresponding to the driving signal from the at least two second sensing electrodes.

The active area may include a first area, a second area adjacent to the first area in the first direction, a third area adjacent to the first area in the second direction, and a fourth area adjacent to the third area in the first direction, a first one of the at least two first sensing electrodes may be in the third area and the fourth area, and a second one of the at least two first sensing electrodes may be in the first area and the second area.

The first sensing period may include a first sub-period and a second sub-period, and, in the first sub-period, the sensor driver may be configured to provide a first voltage having a positive voltage level to the first one of the at least two first sensing electrodes in the third area and the fourth area.

In the second sub-period, the sensor driver may be configured to provide a second voltage having a negative voltage level to the second one of the at least two first sensing electrodes in the first area and the second area.

A first one of the at least two second sensing electrodes may be in the first area and the third area, the second sensing period may include a third sub-period and a fourth sub-period, and, in the third sub-period, the sensor driver may be configured to provide the first voltage to the first one of the at least two second sensing electrodes in the first area and the third area.

A second one of the at least two second sensing electrodes may be in the second area and the fourth area, in the fourth sub-period, the sensor driver may be configured to provide the second voltage to the second one of the at least two second sensing electrodes in the second area and the fourth area.

The first multiplexer may include a first terminal connected to the sensor driver, and a plurality of second terminals connected to the at least two first sensing electrodes, respectively, and the first multiplexer may be configured to receive an enable signal and a selection signal.

In the first sensing period, the first terminal may be connected to one of the plurality of second terminals based on the selection signal.

In the third sensing period, the first terminal may be concurrently connected to the plurality of second terminals based on the enable signal.

The sensing frame may further include a fourth sensing period in which the sensor layer operates in a mutual-capacitance manner.

In the fourth sensing period, the first terminal may be connected to one of the plurality of second terminals based on the selection signal.

According to an embodiment, a method of sensing an external input may include a first sensing step of sensing the external input based on a plurality of first sensing electrodes of a sensor layer, a second sensing step of sensing the external input based on a plurality of second sensing electrodes intersecting the plurality of first sensing electrodes of the sensor layer, and a third sensing step of sensing the external input based on the plurality of first sensing electrodes and the plurality of second sensing electrodes of the sensor layer. The third sensing step may include steps of providing a driving signal simultaneously to at least two first sensing electrodes among the plurality of first sensing electrodes by a sensor driver configured to drive the plurality of first sensing electrodes and the plurality of second sensing electrodes, and receiving a sensing signal corresponding to the driving signal from at least two second sensing electrodes among the plurality of second sensing electrodes electrically connected.

An active area of the sensor layer may include a first area, a second area adjacent to the first area in a first direction, a third area adjacent to the first area in a second direction intersecting the first direction, and a fourth area adjacent to the third area in the first direction, and the first sensing step may include providing, at the sensor driver, a first voltage having a positive voltage level to a first one of the at least two first sensing electrodes in the third area and the fourth area.

The first sensing step may further include providing, at the sensor driver, a second voltage having a negative voltage level to a second one of the at least two first sensing electrodes in the first area and the second area.

The second sensing step may include providing, at the sensor driver, the first voltage to a first one of the at least two second sensing electrodes in the first area and the third area.

The second sensing step may further include providing, at the sensor driver, the second voltage to a second one of the at least two second sensing electrodes in the second area and the fourth area. The method may further include calculating a coordinate value of the external input based on signals received at the first sensing step, the second sensing step, and the third sensing step

According to an embodiment, an electronic apparatus may include: a display layer configured to display an image; a sensor layer on the display layer and comprising a plurality of sensing electrodes; and a sensor driver configured to supply a driving signal to the sensor layer and to receive a corresponding sensing signal, wherein the sensor layer may be configured to: operate in a self-capacitance mode in first and second sensing periods, operate in a mutual-capacitance mode in a third sensing period, and determine a coordinate value of an external input based on sensing signals received in the first, second, and third sensing periods.

### BRIEF DESCRIPTION OF DRAWINGS

The above and other objects and features of the disclosure will become apparent by describing in detail embodiments thereof with reference to the accompanying drawings.

FIG. 1 is a block diagram of an electronic device according to an embodiment of the disclosure.

FIG. 2 illustrates schematic views of electronic devices according to various embodiments.

FIG. 3 is a perspective view of an electronic device according to an embodiment of the disclosure.

FIG. 4 is a block diagram illustrating an electronic device according to an embodiment of the disclosure and an external input.

FIG. 5 is a cross-sectional view of a display module according to an embodiment of the disclosure.

FIG. 6 is a cross-sectional view of a display module according to an embodiment of the disclosure.

FIG. 7 is a block diagram of a display layer and a display driver according to an embodiment of the disclosure.

FIG. 8 is a block diagram of a sensor layer and a sensor driver according to an embodiment of the disclosure.

FIG. 9 is an enlarged plan view of a cross area of FIG. 8 according to an embodiment of the disclosure.

FIG. 10 is a cross-sectional view of a sensor layer taken along line I-I’ of FIG. 9, according to an embodiment of the disclosure.

FIG. 11 is a block diagram illustrating a sensor layer and a sensor driver according to an embodiment of the disclosure.

FIG. 12 is a circuit diagram of a first multiplexer according to an embodiment of the disclosure.

FIG. 13 is a flowchart illustrating a driving method of an electronic device according to an embodiment of the disclosure.

FIG. 14 is a diagram for describing operations of a display driver and a sensor driver according to an embodiment of the disclosure.

FIG. 15 is a block diagram illustrating a first sensing period according to an embodiment of the disclosure.

FIG. 16 is a block diagram of a sensor layer and a sensor driver illustrating an operation of a first sensing step according to an embodiment of the disclosure.

FIG. 17 is a diagram for describing a sensor layer and a sensor driver operating in a self-capacitance manner according to an embodiment of the disclosure.

FIG. 18 is a block diagram of a sensor layer and a sensor driver illustrating an operation of a first sensing step according to an embodiment of the disclosure.

FIG. 19 is a block diagram illustrating a second sensing period according to an embodiment of the disclosure.

FIG. 20 is a block diagram of a sensor layer and a sensor driver illustrating an operation of a second sensing step according to an embodiment of the disclosure.

FIG. 21 is a block diagram of a sensor layer and a sensor driver illustrating an operation of a second sensing step according to an embodiment of the disclosure.

FIG. 22 is a block diagram of a sensor layer and a sensor driver illustrating an operation of a third sensing step according to an embodiment of the disclosure.

FIG. 23 is a diagram for describing a sensor layer and a sensor driver operating in a mutual-capacitance manner according to an embodiment of the disclosure.

FIG. 24 is a block diagram of a sensor layer illustrating an operation of a processing period according to an embodiment of the disclosure.

FIG. 25 is a diagram for describing operations of a display driver and a sensor driver according to an embodiment of the disclosure.

FIG. 26 is a block diagram of a sensor layer and a sensor driver illustrating an operation of a third sensing step according to an embodiment of the disclosure.

### DETAILED DESCRIPTION

The embodiments described herein are non-limiting example embodiments, and thus, the disclosure is not limited thereto and may be realized in various other forms. In the disclosure, the expression that a first component (or an area, a layer, a part, or a portion) is “on”, “connected to”, or “coupled to” a second component means that the first component is directly on/connected to/coupled to the second component or means that a third component is interposed therebetween. Further, when two or more elements (or components, or layers) are described as being “electrically connected,” these two or more elements may be in a state of electrically connected or being configured to be electrically connected when power is supplied to a device including the two or more elements.

The same reference numerals/signs refer to the same components. In addition, in drawings, thicknesses, proportions, and dimensions of components may be exaggerated to describe the technical features effectively. The expression “and/or” includes one or more combinations which associated components are capable of defining.

Even though the terms “first”, “second”, etc. may be used to describe various components, the components should not be construed as being limited by the terms. The terms are used only for the purpose of distinguishing one component, part, area, layer, or portion from another component, part, area, layer, or portion. For example, without departing from the scope of the disclosure, a first component, a first part, a first area, a first layer, or a first portion may be named a second component, a second part, a second area, a second layer, or a second portion, and similarly, the second component, the second part, the second area, the second layer, or the second portion may be named the first component, the first part, the first area, the first layer, or the first portion. The articles “a”, “an”, and “the” are singular in that they have a single referent, but the use of the singular form should not preclude the presence of more than one referent.

Also, the terms “under”, “below”, “on”, “above”, etc. are used to describe the correlation of components illustrated in drawings. The terms that are relative in concept are described based on a direction shown in drawings.

It will be understood that the terms “include”, “comprise”, “have”, etc. specify the presence of features, numbers, steps, operations, elements, or components, described in the disclosure, or a combination thereof, not precluding the presence or additional possibility of one or more other features, numbers, steps, operations, elements, or components or a combination thereof.

Unless defined otherwise, all terms (including technical and scientific terms) used herein have the same meaning as commonly understood by one of ordinary skill in the art to which this disclosure belongs. In addition, the terms such as terms defined in the dictionaries commonly used should be interpreted as having a meaning consistent with the meaning in the context of the related technology, and should not be interpreted in ideal or overly formal meanings unless explicitly defined herein.

Hereinafter, embodiments of the disclosure will be described with reference to accompanying drawings.

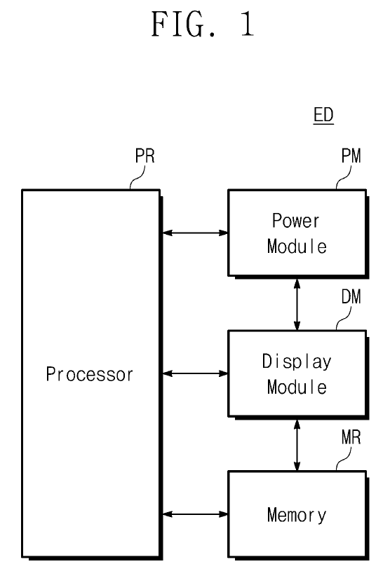

FIG. 1 is a block diagram of an electronic device according to an embodiment of the disclosure.

An electronic device according to an embodiment of the disclosure may be provided in various forms and shapes. The electronic device according to an embodiment of the disclosure may further include a module or device which has any other additional functions.

Referring to FIG. 1, an electronic device ED according to an embodiment may include a display module DM, a processor PR, a memory MR, and a power module PM.

The processor PR may include at least one of a central processing unit (CPU), an application processor (AP), a graphics processing unit (GPU), a communication processor (CP), an image signal processor (ISP), and a controller. The processor PR may control the power module PM, the display module DM, and the memory MR.

Data and information for operations of the processor PR or the display module DM may be stored in the memory MR. When the processor PR executes an application stored in the memory MR, an image data signal and/or an input control signal may be transferred to the display module DM, and the display module DM may process the provided signal to output image information through a display screen.

The power module PM may include a power supply module such as a power adapter or a battery device and a power conversion module which converts the power supplied by the power supply module into operating voltages required for the electronic device ED.

The display module DM may operate based on electrical signals. Some individual modules, which are functionally included in one module, may be included in the display module DM, and others individual modules may be implemented in the electronic device ED independently of the display module DM.

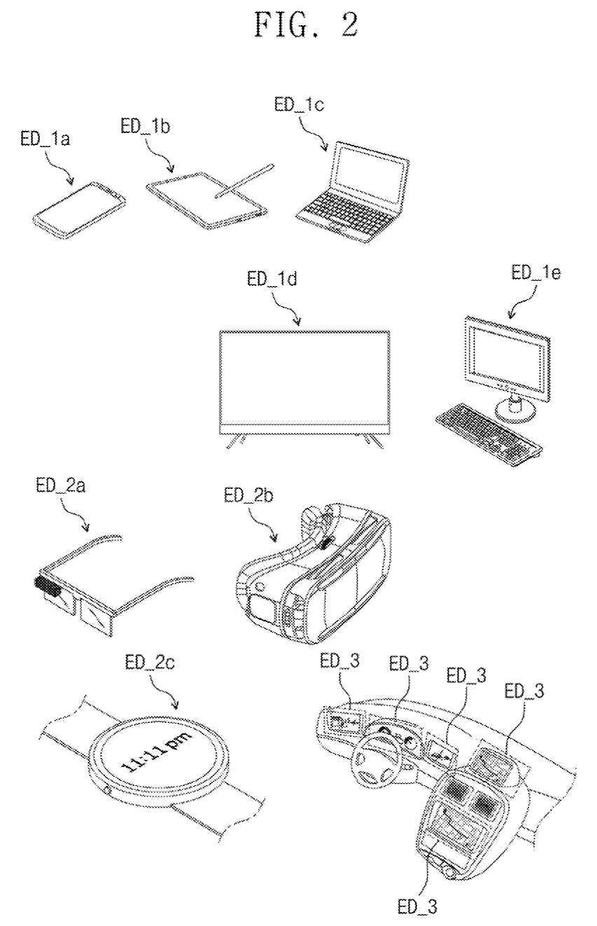

FIG. 2 illustrates schematic views of electronic devices according to various embodiments.

Referring to FIG. 2, an electronic device according to various embodiments may be a wearable electronic device including a display module such as smart glasses ED-2a, a head-mounted display ED-2b, and a smartwatch ED-2c, as well as an image display device such as a smartphone ED-1a, a tablet PC ED-1b, a laptop ED-1c, a television (TV) ED-1d, and a desktop monitor ED-1e.

For example, the electronic device according to various embodiments may be applied within a transport device such as a vehicle and may provide various information to the user through an image. For example, the electronic device according to an embodiment may be provided in the form of an automotive electronic device ED-3 including display modules such as an instrument panel, a center fascia, a center information display (CID) disposed on a dashboard, and a room mirror display of a vehicle.

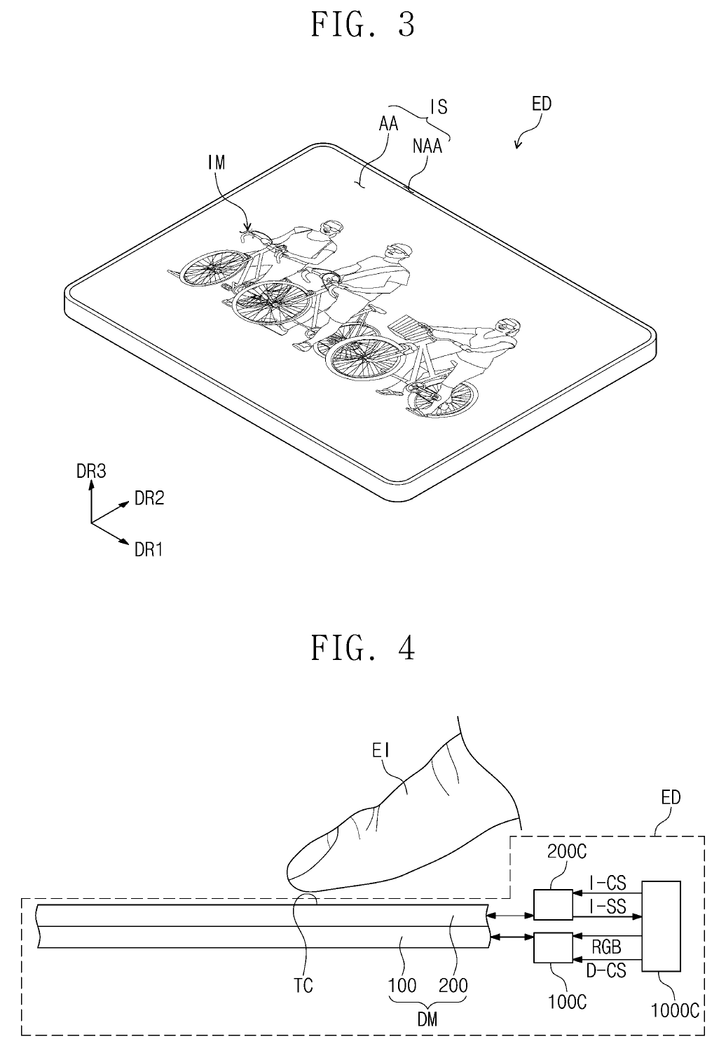

FIG. 3 is a perspective view of an electronic device according to an embodiment of the disclosure.

Referring to FIG. 3, the electronic device ED may be activated based on an electrical signal. The electronic device ED according to an embodiment may be a small-sized or medium-sized electronic device, such as a mobile phone, a tablet, a notebook, an automotive navigation system, an automotive display panel, or a game console, as well as a large-sized electronic device such as a television or a monitor. The above electronic devices are examples, the electronic device ED may be implemented as various other electronic devices. The electronic device ED may have a rectangular shape having a long side extending in a first direction DR1 and a short side extending in a second direction DR2 intersecting the first direction DR1. However, the shape of the electronic device ED is not limited thereto. For example, the electronic device ED may be implemented in various shapes. The electronic device ED may display an image IM on a display surface IS, which is parallel to the first direction DR1 and the second direction DR2, and faces a third direction DR3. The display surface IS, on which the image IM is displayed, may correspond to a front surface of the electronic device ED.

In an embodiment, a front surface (or an upper/top surface) and a rear surface (or a lower/bottom surface) of each member may be defined with respect to a direction in which the image IM is displayed. The front surface and the rear surface may be opposite to (or face) each other in the third direction DR3, and the normal direction of each of the front surface and the rear surface may be parallel to the third direction DR3.

A separation distance between the front surface and the rear surface in the third direction DR3 may correspond to a thickness of the electronic device ED in the third direction DR3. Meanwhile, directions that the first, second, and third directions DR1, DR2, and DR3 indicate may be relative and may be defined differently according to device orientation.

The electronic device ED may sense an external input applied from outside. The external input may include various types of inputs provided from outside the electronic device ED. The electronic device ED according to an embodiment of the disclosure may sense an external input of a user. The external input of the user may one of various types of external inputs, such as a part of his/her body, a light, heat, his/her eye, and pressure, or a combination thereof. For example, the electronic device ED may sense the external input of the user, which is applied to the side surface or rear surface of the electronic device ED according to a structure of the electronic device ED, and the disclosure is not limited thereto.

The display surface IS of the electronic device ED may be divided into an active area AA and a non-active area NAA. The active area AA may refer to a region in which the image IM is displayed. The user may visually perceive the image IM through the active area AA. In an embodiment, the active area AA is illustrated in the shape of a quadrangle whose corners are rounded. However, this is an example. The active area AA may be implemented in various shapes and may not be limited to a specific geometry.

The non-active area NAA may be adjacent to the active area AA. The non-active area NAA may have a certain color or certain pattern. The non-active area NAA may surround the active area AA. Accordingly, the shape (or boundary) of the active area AA may be defined substantially by the non-active area NAA. However, this is an example. For example, the non-active area NAA may be only disposed adjacent to one side of the active area AA or may be omitted. However, the disclosure is not limited thereto.

FIG. 4 is a block diagram illustrating an electronic device according to an embodiment of the disclosure and an external input.

Referring to FIG. 4, the electronic device ED may include the display module DM, a display driver 100C, a sensor driver 200C, and a main controller 1000C. The display module DM may include a display layer 100 and a sensor layer 200.

The display layer 100 may generate an image. The display layer 100 may be a light emitting display layer. For example, the display layer 100 may be an organic light emitting display layer, a quantum dot display layer, a micro-LED display layer, or a nano-LED display layer.

The sensor layer 200 may be disposed on the display layer 100. The sensor layer 200 may sense an external input applied from the outside. For example, the sensor layer 200 may sense an external input TC caused by a body EI of the user.

The main controller 1000C may control overall operations of the electronic device ED. For example, the main controller 1000C may control operations of the display driver 100C and the sensor driver 200C. The main controller 1000C may include at least one microprocessor, and the processor PR (refer to FIG. 1) may include the main controller 1000C.

The display driver 100C may control the display layer 100. The main controller 1000C may further include a graphics controller. The display driver 100C may receive image data RGB and a control signal D-CS from the main controller 1000C. The control signal D-CS may include various signals. For example, the control signal D-CS may include an input vertical synchronization signal, an input horizontal synchronization signal, a main clock, a data enable signal, and the like. Based on the control signal D-CS, the display driver 100C may generate a vertical synchronization signal and a horizontal synchronization signal for controlling the timing to provide signals to the display layer 100.

The sensor driver 200C may control the sensor layer 200. The sensor driver 200C may receive a control signal I-CS from the main controller 1000C. The control signal I-CS may include a mode selection signal for determining a driving mode of the sensor driver 200C and a clock signal. The sensor driver 200C may operate in a mode of sensing the external input TC caused by the body EI of the user, based on the control signal I-CS.

The sensor driver 200C may calculate coordinates of the external input TC based on the signals received from the sensor layer 200 and may provide a coordinate value I-SS including coordinate information to the main controller 1000C.

The main controller 1000C may control or execute an operation corresponding to the user input based on the coordinate value I-SS. For example, the main controller 1000C may drive the display driver 100C such that a new application image may be displayed on the display layer 100 based on the coordinate value I-SS.

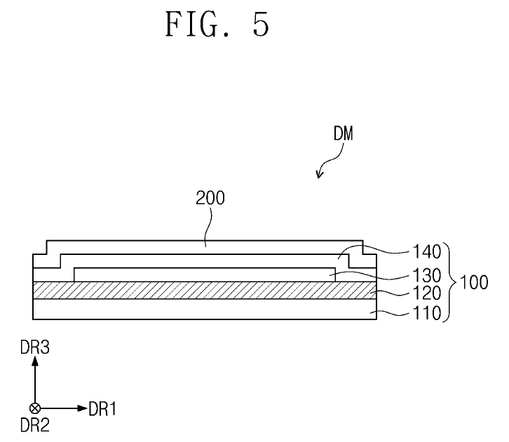

FIG. 5 is a cross-sectional view of a display module according to an embodiment of the disclosure.

Referring to FIG. 5, the display module DM may include the display layer 100 and the sensor layer 200. The display layer 100 may include a base layer 110, a circuit layer 120, a light emitting element layer 130, and an encapsulation layer 140.

The base layer 110 may provide a base surface on which the circuit layer 120 is disposed. The base layer 110 may be a glass substrate, a metal substrate, or a polymer substrate. However, the disclosure is not limited thereto. For example, the base layer 110 may include an inorganic layer, an organic layer, or a composite material layer.

The base layer 110 may have a multilayer structure. For example, the base layer 110 may include a first synthetic resin layer, a silicon oxide (SiOₓ) layer disposed on the first synthetic resin layer, an amorphous silicon (a-Si) layer disposed on the silicon oxide layer, and a second synthetic resin layer disposed on the amorphous silicon layer. The silicon oxide layer and the amorphous silicon layer may be referred to as a “base barrier layer.”

Each of the first and second synthetic resin layers may include polyimide-based resin. For example, each of the first and second synthetic resin layers may include at least one of an acrylate-based resin, a methacrylate-based resin, a polyisoprene-based resin, a vinyl-based resin, an epoxy-based resin, a urethane-based resin, a cellulose-based resin, a siloxane-based resin, a polyamide-based resin, and a perylene-based resin. In the disclosure, the wording “~~-based resin” indicates that “~~-based resin” includes the functional group of “~~”.

The circuit layer 120 may be disposed on the base layer 110. The circuit layer 120 may include an insulating layer, a semiconductor pattern, a conductive pattern, a signal line, and the like. The insulating layer, the semiconductor layer, and the conductive layer may be formed on the base layer 110 through a coating process or a deposition process, and the insulating layer, the semiconductor layer, and the conductive layer may be selectively patterned through a plurality of photolithography processes. Then, the insulating layer, the semiconductor pattern, the conductive pattern, and the signal line included in the circuit layer 120 may be formed.

The light emitting element layer 130 may be disposed on the circuit layer 120, and may include a light emitting element. For example, the light emitting element layer 130 may include an organic light emitting material, a quantum dot, a quantum rod, a micro-LED, or a nano-LED.

The encapsulation layer 140 may be disposed on the light emitting element layer 130, and may protect the light emitting element layer 130 from foreign substances such as moisture, oxygen, and dust particles.

The sensor layer 200 may be formed on the display layer 100. The sensor layer 200 and the display layer 100 may be formed by the same process. For example, the sensor layer 200 may be expressed as being directly disposed on the display layer 100. The expression “being directly disposed” may indicate that a third component is not interposed between the sensor layer 200 and the display layer 100. For example, a separate adhesive member may not be interposed between the sensor layer 200 and the display layer 100. In another example, the sensor layer 200 may be coupled to the display layer 100 through an adhesive member. The adhesive member may include a typical adhesive or sticking agent.

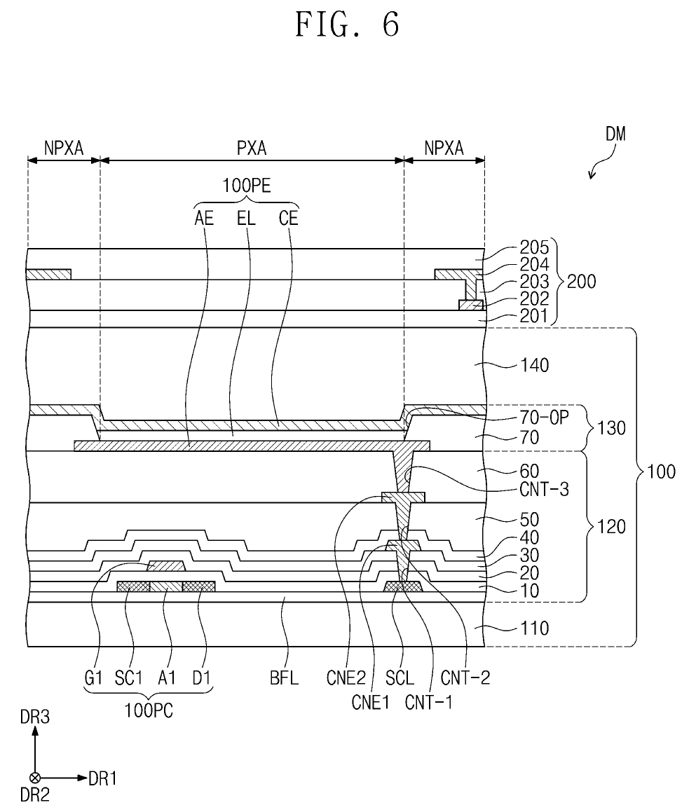

FIG. 6 is a cross-sectional view of a display module according to an embodiment of the disclosure. In the description of FIG. 6, the components which are described with reference to FIG. 5 are denoted by the same reference numerals/signs, and thus, additional description will be omitted to avoid redundancy.

Referring to FIG. 6, at least one inorganic layer may be formed on an upper surface of the base layer 110. The inorganic layer may include at least one of aluminum oxide, titanium oxide, silicon oxide, silicon nitride, silicon oxynitride, zirconium oxide, and hafnium oxide. The inorganic layer may be formed as multiple layers. The multiple inorganic layers may constitute a barrier layer and/or a buffer layer. In an embodiment, the display layer 100 may include a buffer layer BFL.

The buffer layer BFL may improve a bonding force between the base layer 110 and a semiconductor pattern. The buffer layer BFL may include a silicon oxide layer and a silicon nitride layer, and the silicon oxide layer and the silicon nitride layer may be alternately stacked.

The semiconductor pattern may be disposed on the buffer layer BFL. The semiconductor pattern may include polysilicon. However, the disclosure is not limited thereto. For example, the semiconductor pattern may include amorphous silicon, low-temperature polycrystalline silicon, or an oxide semiconductor.

FIG. 6 shows only a portion of the semiconductor pattern, and a remaining portion of the semiconductor pattern may be further disposed in other area. The semiconductor patterns may be arranged across pixels in a specific rule or a specific layout. An electrical characteristics of the semiconductor pattern may vary according to whether the semiconductor pattern is doped or not. The semiconductor pattern may include a first region having higher conductivity and a second region having lower conductivity. The first region may be doped with an N-type dopant or a P-type dopant. A P-type transistor may include a doped region doped with the P-type dopant, and an N-type transistor may include a doped region doped with the N-type dopant. The second region may be an undoped region or may be a region doped at a concentration lower than that of the first region.

The conductivity of the first region may be greater than the conductivity of the second region and may substantially function as an electrode or a signal line. The second region may substantially correspond to an active region (or channel region) of a transistor. In other words, a portion of the semiconductor pattern may be an active region of a transistor, another portion thereof may be a source region or a drain region of the transistor, and another portion thereof may be a connection electrode or a connection signal line.

Each pixel may have an equivalent circuit including seven transistors, one capacitor, and one light emitting element, and the equivalent circuit of the pixel may be modified in various forms. For example, one transistor 100PC and one light emitting element 100PE which are included in the pixel are illustrated in FIG. 6.

The transistor 100PC may include a source region SC1, an active region A1, a drain region D1, and a gate G1. The source region SC1, the active region A1, and the drain region D1 may be formed from the semiconductor pattern. In a cross-sectional view, the source region SC1 and the drain region D1 may extend from the active region A1 in directions facing away from each other. A portion of a connection signal line SCL formed from the semiconductor pattern is illustrated in FIG. 6. In a plan view, the connection signal line SCL may be connected to the drain region D1 of the transistor 100PC.

A first insulating layer 10 may be disposed on the buffer layer BFL. The first insulating layer 10 may overlap a plurality of pixels in common and may cover the semiconductor pattern. The first insulating layer 10 may be an inorganic layer and/or an organic layer, and may have a single-layer structure or a multilayer structure. The first insulating layer 10 may include at least one of aluminum oxide, titanium oxide, silicon oxide, silicon nitride, silicon oxynitride, zirconium oxide, and hafnium oxide. In an embodiment, the first insulating layer 10 may be a single silicon oxide layer. Not only the first insulating layer 10 but also an insulating layer of the circuit layer 120 to be described later may be an inorganic layer and/or an organic layer, and may have a single layer structure or a multilayer structure. The inorganic layer may include at least one of the above-described materials, but the disclosure is not limited thereto.

A gate G1 may be disposed on the first insulating layer 10. The gate G1 may be a portion of a metal pattern. The gate G1 overlaps the active region A1. The gate G1 may function as a mask in the process of doping the semiconductor pattern.

The second insulating layer 20 may be disposed on the first insulating layer 10 and may cover the gate G1. The second insulating layer 20 may overlap the pixels in common. The second insulating layer 20 may be an inorganic layer and/or an organic layer and may have a single-layer or multilayer structure. The second insulating layer 20 may include at least one of silicon oxide, silicon nitride, and silicon oxynitride. In an embodiment, the second insulating layer 20 may have a multilayer structure including a silicon oxide layer and a silicon nitride layer.

A third insulating layer 30 may be disposed on the second insulating layer 20, and may have a single-layer or multilayer structure. For example, the third insulating layer 30 may have a multilayer structure including a silicon oxide layer and a silicon nitride layer.

A first connection electrode CNE1 may be disposed on the third insulating layer 30, and may be connected to the connection signal line SCL through a contact hole CNT-1 penetrating the first, second, and third insulating layers 10, 20, and 30.

A fourth insulating layer 40 may be disposed on the third insulating layer 30, and may be formed as a single silicon oxide layer. A fifth insulating layer 50 may be disposed on the fourth insulating layer 40. The fifth insulating layer 50 may be an organic layer.

A second connection electrode CNE2 may be disposed on the fifth insulating layer 50, and may be connected to the first connection electrode CNE1 through a contact hole CNT-2 penetrating the fourth insulating layer 40 and the fifth insulating layer 50.

A sixth insulating layer 60 may be disposed on the fifth insulating layer 50 and may cover the second connection electrode CNE2. The sixth insulating layer 60 may be formed as an organic layer.

The light emitting element layer 130 may be disposed on the circuit layer 120. The light emitting element layer 130 may include the light emitting element 100PE. For example, the light emitting element layer 130 may include an organic light emitting material, a quantum dot, a quantum rod, a micro-LED, or a nano-LED. Hereinafter, the description will be given under the condition that the light emitting element 100PE is an organic light emitting element, but the disclosure is not limited thereto.

The light emitting element 100PE may include a first electrode AE, an emissive layer (e.g., light emitting layer) EL, and a second electrode CE. The first electrode AE may be disposed on the sixth insulating layer 60. The first electrode AE may be connected to the second connection electrode CNE2 through a contact hole CNT-3 penetrating the sixth insulating layer 60.

A pixel defining layer 70 may be disposed on the sixth insulating layer 60 and may cover a portion of the first electrode AE. An opening 70-OP may be defined in the pixel defining layer 70. The opening 70-OP of the pixel defining layer 70 may expose at least a portion of the first electrode AE.

The active area AA (refer to FIG. 3) may include an emission area PXA and a non-emission area NPXA adjacent to the emission area PXA. The non-emission area NPXA may surround the emission area PXA. In an embodiment, the emission area PXA may be defined to correspond to a partial area of the first electrode AE exposed by the opening 70-OP.

The emissive layer EL may be disposed on the first electrode AE. The emissive layer EL may be disposed in the area defined by the opening 70-OP. For example, the emissive layer EL may be independently formed for each pixel. When the emissive layer EL is independently formed for each pixel, each of the emissive layers EL may emit at least one of a blue light, a red light, and a green light. However, the disclosure is not limited thereto. For example, the emissive layer EL may be connected to the pixels in common. For example, the emissive layer EL may provide a blue light or may provide a white light.

The second electrode CE may be disposed on the emissive layer EL. The second electrode CE may have an integrated shape and may be disposed in the plurality pixels in common.

For example, a hole control layer may be disposed between the first electrode AE and the emissive layer EL. The hole control layer may be disposed in common in the emission area PXA and the non-emission area NPXA. The hole control layer may include a hole transport layer and may further include a hole injection layer. An electron control layer may be disposed between the emissive layer EL and the second electrode CE. The electron control layer may include an electron transport layer and may further include an electron injection layer. The hole control layer and the electron control layer may be formed in the plurality of pixels in common by using an open mask.

The encapsulation layer 140 may be disposed on the light emitting element layer 130. The encapsulation layer 140 may include an inorganic layer, an organic layer, and an inorganic layer that are sequentially stacked with each other, but the layers of the encapsulation layer 140 are not limited thereto.

The inorganic layers may protect the light emitting element layer 130 from moisture and oxygen, and the organic layer may protect the light emitting element layer 130 from a foreign material such as dust particles. The inorganic layers may include at least one of silicon nitride, silicon oxynitride, silicon oxide, titanium oxide, aluminum oxide, and/or the like. The organic layer may include an acrylic-based organic material, but the disclosure is not limited thereto.

The sensor layer 200 may be formed on the display layer 100. The sensor layer 200 and the display layer 100 may be formed by the same process. For example, the sensor layer 200 may be expressed as being directly disposed on the display layer 100. The expression “being directly disposed” may indicate that a third component is not interposed between the sensor layer 200 and the display layer 100. For example, a separate adhesive member may not be interposed between the sensor layer 200 and the display layer 100. In another example, the sensor layer 200 may be bonded to the display layer 100 through an adhesive member. The adhesive member may include a typical adhesive or sticking agent.

The sensor layer 200 may include a sensor base layer 201, a first conductive layer 202, a sensing insulating layer 203, a second conductive layer 204, and a cover insulating layer 205.

The sensor base layer 201 (e.g., insulating layer) may be an inorganic layer including at least one of silicon nitride, silicon oxynitride, and silicon oxide. In another example, the sensor base layer 201 may be an organic layer including an epoxy resin, an acrylic resin, or an imide-based resin. The sensor base layer 201 may have a single-layer structure or may be a structure in which a plurality of layers are stacked along the third direction DR3.

Each of the first conductive layer 202 and the second conductive layer 204 may have a single-layer structure or may have a structure in which a plurality of layers are stacked in the third direction DR3.

A conductive layer of a single-layer structure may include a metal layer or a transparent conductive layer. The metal layer may include molybdenum, silver, titanium, copper, aluminum, or an alloy thereof. The transparent conductive layer may include a transparent conductive oxide such as indium tin oxide (ITO), indium zinc oxide (IZO), zinc oxide (ZnO), or indium zinc tin oxide (IZTO). For example, the transparent conductive layer may include a conductive polymer such as poly(3,4-ethylenedioxythiophene) (PEDOT), a metal nanowire, graphene, and the like.

The conductive layer of the multilayer structure may include a plurality of metal layers. The metal layers may have, for example, a three-layer structure of titanium/aluminum/titanium. The conductive layer of the multilayer structure may include at least one metal layer and at least one transparent conductive layer.

At least one of the sensing insulating layer 203 and the cover insulating layer 205 may include an inorganic layer. The inorganic layer may include at least one of aluminum oxide, titanium oxide, silicon oxide, silicon nitride, silicon oxynitride, zirconium oxide, and hafnium oxide.

At least one of the sensing insulating layer 203 and the cover insulating layer 205 may include an organic layer. The organic layer may include at least one of an acrylic-based resin, a methacrylic-based resin, a polyisoprene, vinyl-based resin, an epoxy-based resin, a urethane-based resin, a cellulose-based resin, siloxane-based resin, a polyimide-based resin, a polyamide-based resin, and a perylene-based resin.

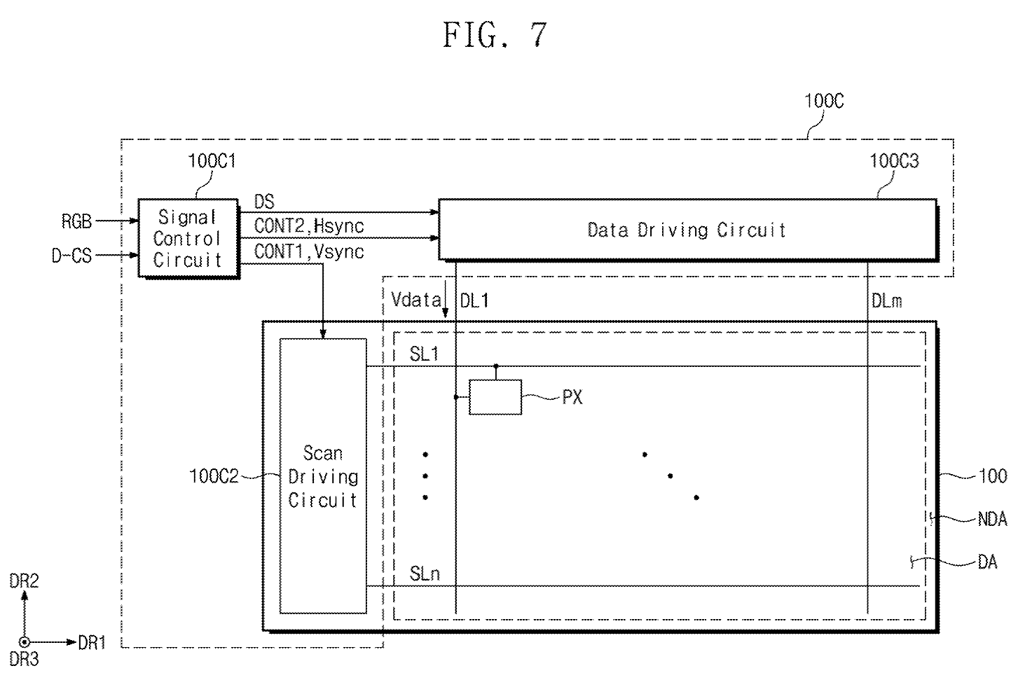

FIG. 7 is a block diagram of a display layer and a display driver according to an embodiment of the disclosure.

Referring to FIG. 7, the display layer 100 may include a plurality of scan lines SL1 to SLn, a plurality of data lines DL1 to DLm, and a plurality of pixels PX. Each of the plurality of pixels PX may be connected to a corresponding data line among the plurality of data lines DL1 to DLm and may be connected to a corresponding scan line among the plurality of scan lines SL1 to SLn. In an embodiment of the disclosure, the display layer 100 may further include emission control lines, and the display driver 100C may further include an emission driving circuit which provides control signals to the emission control lines. A configuration of the display layer 100 is not limited.

The display layer 100 may include a display area DA and a non-display area NDA. The display area DA may be defined as an area in which the image IM (refer to FIG. 3) is displayed. According to an embodiment, the display area DA may correspond to (or may overlap) at least a portion of the active area AA (refer to FIG. 3).

The non-display area NDA may be adjacent to the display area DA. The non-display area NDA may be an area where the image IM (refer to FIG. 3) is not substantially displayed. For example, the non-display area NDA may surround the display area DA. However, this is an example, and the non-display area NDA may be defined in various shapes without limitation to any one embodiment.

The display driver 100C may include a signal control circuit 100C1, a scan driving circuit 100C2, and a data driving circuit 100C3.

The signal control circuit 100C1 may receive the image data RGB and the control signal D-CS from the processor PR (refer to FIG. 1). The control signal D-CS may include various signals. For example, the control signal D-CS may include an input vertical synchronization signal, an input horizontal synchronization signal, a main clock, a data enable signal, and the like.

The signal control circuit 100C1 may generate a first control signal CONT1 and a vertical synchronization signal Vsync based on the control signal D-CS and may output the first control signal CONT1 and the vertical synchronization signal Vsync to the scan driving circuit 100C2. The vertical synchronization signal Vsync may be included in the first control signal CONT1.

The signal control circuit 100C1 may generate a second control signal CONT2 and a horizontal synchronization signal Hsync based on the control signal D-CS and may output the second control signal CONT2 and the horizontal synchronization signal Hsync to the data driving circuit 100C3. The horizontal synchronization signal Hsync may be included in the second control signal CONT2.

For example, the signal control circuit 100C1 may output a data signal DS, which is obtained by processing the image data RGB so as to satisfy operating conditions of the display layer 100, to the data driving circuit 100C3. The first control signal CONT1 and the second control signal CONT2 which are signals for the operations of the scan driving circuit 100C2 and the data driving circuit 100C3 are not limited.

The scan driving circuit 100C2 may drive the plurality of scan lines SL1 to SLn in response to the first control signal CONT1 and the vertical synchronization signal Vsync. In an embodiment of the disclosure, the scan driving circuit 100C2 may be formed in the same process as the circuit layer 120 (refer to FIG. 5) in the display layer 100, but the disclosure is not limited thereto. For example, the scan driving circuit 100C2 may be implemented as an integrated circuit (IC). For the electrical connection with the display layer 100, the IC may be mounted (e.g., directly mounted) on a given area of the display layer 100 or may be mounted on a separate printed circuit board in a chip-on-film (COF) manner.

The data driving circuit 100C3 may output data voltages Vdata for driving the plurality of data lines DL1 to DLm in response to the second control signal CONT2, the horizontal synchronization signal Hsync, and the data signal DS from the signal control circuit 100C1. The data driving circuit 100C3 may be implemented as an integrated circuit; for the electrical connection with the display layer 100, the integrated circuit may be mounted (e.g., directly mounted) on a given area of the display layer 100 or may be mounted on a separate printed circuit board in the chip-on-film (COF) manner. However, the disclosure is not limited thereto. For example, the data driving circuit 100C3 may be formed in the same process as the circuit layer 120 (refer to FIG. 5) of the display layer 100.

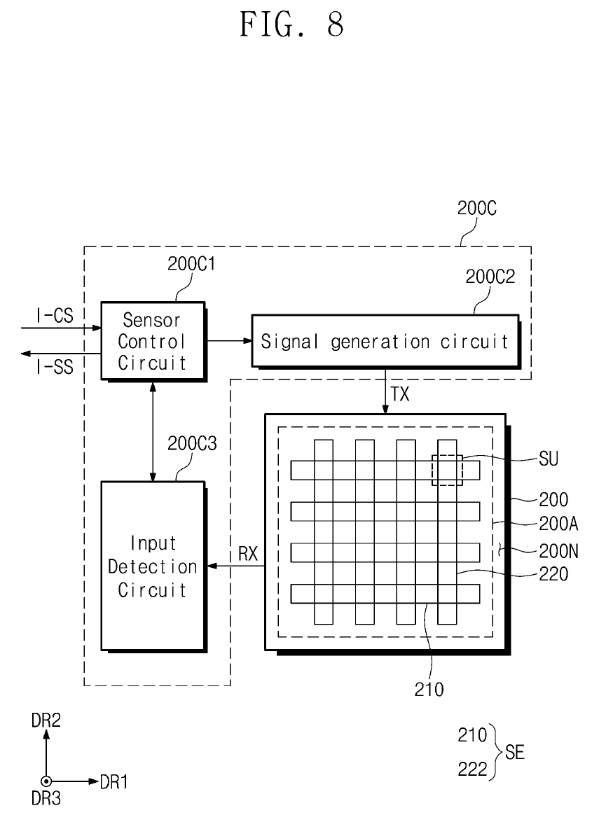

FIG. 8 is a block diagram of a sensor layer and a sensor driver according to an embodiment of the disclosure.

Referring to FIG. 8, an active area 200A and a surrounding area 200N may be defined in the sensor layer 200. The active area 200A may be an area which is activated depending on an electrical signal. For example, the active area 200A may be an area in which an input is sensed. The active area 200A may overlap the active area AA (refer to FIG. 3) of the electronic device ED (refer to FIG. 3). The surrounding area 200N may surround the active area 200A. The surrounding area 200N may overlap the non-active area NAA (refer to FIG. 3) of the electronic device ED (refer to FIG. 3).

The sensor layer 200 may include a plurality of sensing electrodes SE. The plurality of sensing electrodes SE may be disposed in the active area 200A. Each of the plurality of sensing electrodes SE may be referred to as a “sensing channel”. The plurality of sensing electrodes SE may include a plurality of first sensing electrodes 210 and a plurality of second sensing electrodes 220. Each of the plurality of first sensing electrodes 210 may extend in the first direction DR1, and the plurality of first sensing electrodes 210 may be arranged to be spaced apart from each other in the second direction DR2. Each of the plurality of second sensing electrodes 220 may extend in the second direction DR2, and the plurality of second sensing electrodes 220 may be arranged to be spaced apart from each other in the first direction DR1.

The plurality of second sensing electrodes 220 may intersect the plurality of first sensing electrodes 210 and may be insulated from the plurality of first sensing electrodes 210. Each of areas, in which the plurality of second sensing electrodes 220 intersect the plurality of first sensing electrodes 210, may be defined as a cross area SU.

The sensor driver 200C may receive the touch control signal I-CS from the main controller 1000C (refer to FIG. 4) and may provide the coordinate value I-SS to the main controller 1000C (refer to FIG. 4).

The sensor driver 200C may include a sensor control circuit 200C1, a signal generation circuit 200C2, and an input detection circuit 200C3. The sensor control circuit 200C1, the signal generation circuit 200C2, and the input detection circuit 200C3 may be implemented in a single chip. In another example, some of the sensor control circuit 200C1, the signal generation circuit 200C2, and the input detection circuit 200C3 and the other(s) thereof may be implemented in different chips from each other.

The sensor control circuit 200C1 may control the operation of the signal generation circuit 200C2, and the sensor control circuit 200C1 may calculate coordinates of an external input from a sensing signal received from the input detection circuit 200C3 or may analyze information transmitted from an external device from a modulation signal received from the input detection circuit 200C3.

The signal generation circuit 200C2 may provide a driving signal (or output signal) TX to the sensor layer 200. The signal generation circuit 200C2 may output the driving signal TX, in synchronization with a sensing frame, to the sensor layer 200.

The input detection circuit 200C3 may receive a sensing signal RX from the sensor layer 200. The sensing signal RX may be an analog signal. The input detection circuit 200C3 may amplify and filter the received analog signal. Then, the input detection circuit 200C3 may convert the filtered signal into a digital signal.

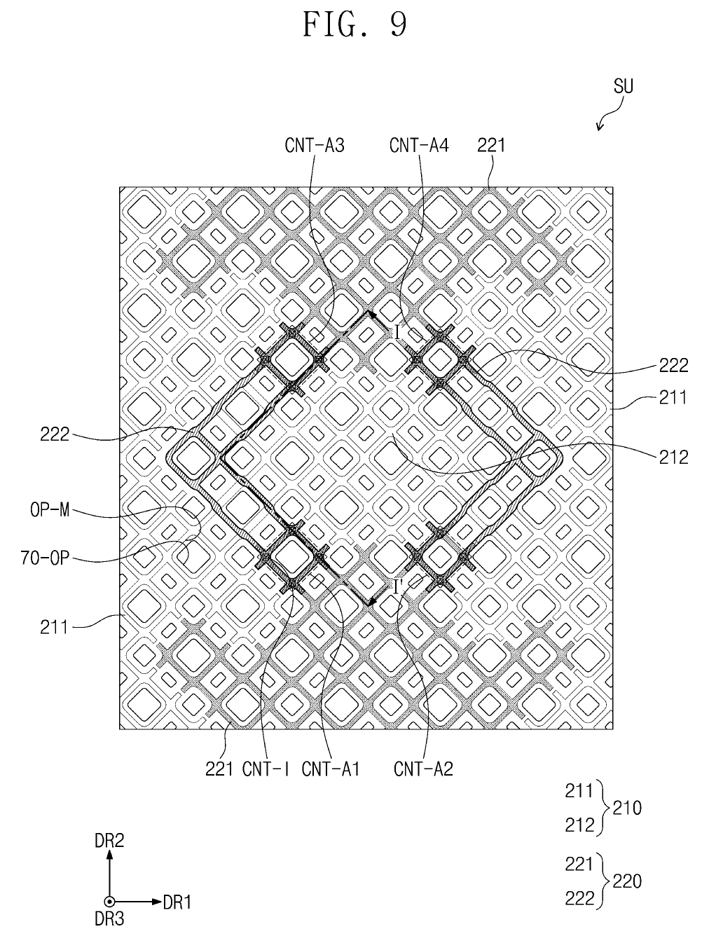

FIG. 9 is an enlarged plan view of a cross area of FIG. 8 according to an embodiment of the disclosure.

Referring to FIG. 9, the cross area SU may be an area where a plurality of bridge patterns 222 are disposed.

Each of the plurality of first sensing electrodes 210 may include a plurality of first portions 211 and a second portion 212. Each of the plurality of second sensing electrodes 220 may include a plurality of sensing patterns 221 and a plurality of bridge patterns 222.

Each of the plurality of sensing patterns 221 may have a mesh structure. An opening OP-M may be defined in each of the plurality of sensing patterns 221. One opening OP-M may overlap the opening 70-OP defined in the pixel defining layer 70 (refer to FIG. 6). However, this is only an example. For example, one opening OP-M may overlap the plurality of openings 70-OP. Each of the plurality of first portions 211 and the second portion 212 may have a mesh structure similar to that of the plurality of sensing patterns 221.

Two bridge patterns 222 may connect two sensing patterns 221. First, second, third, and fourth connection areas CNT-A1, CNT-A2, CNT-A3, and CNT-A4 may be provided between two bridge patterns 222 and two sensing patterns 221. Four contact holes CNT-I may be formed in the first, second, third, and fourth connection areas CNT-A1, CNT-A2, CNT-A3, and CNT-A4, respectively. However, this is provided only as an example, and two sensing patterns 221 may be electrically connected by one bridge pattern. In another embodiment of the disclosure, two sensing patterns 221 may be electrically connected by three or more bridge patterns.

FIG. 10 is a cross-sectional view of a sensor layer taken along line I-I’ of FIG. 9, according to an embodiment of the disclosure.

Referring to FIG. 10, the sensor layer 200 may have a bottom bridge structure. For example, the bridge pattern 222 may be included in the first conductive layer 202 (refer to FIG. 6), and the sensing pattern 221 and the second portion 212 may be included in the second conductive layer 204 (refer to FIG. 6). The sensing pattern 221 may be connected to the bridge pattern 222 through the contact hole CNT-I penetrating the sensing insulating layer 203.

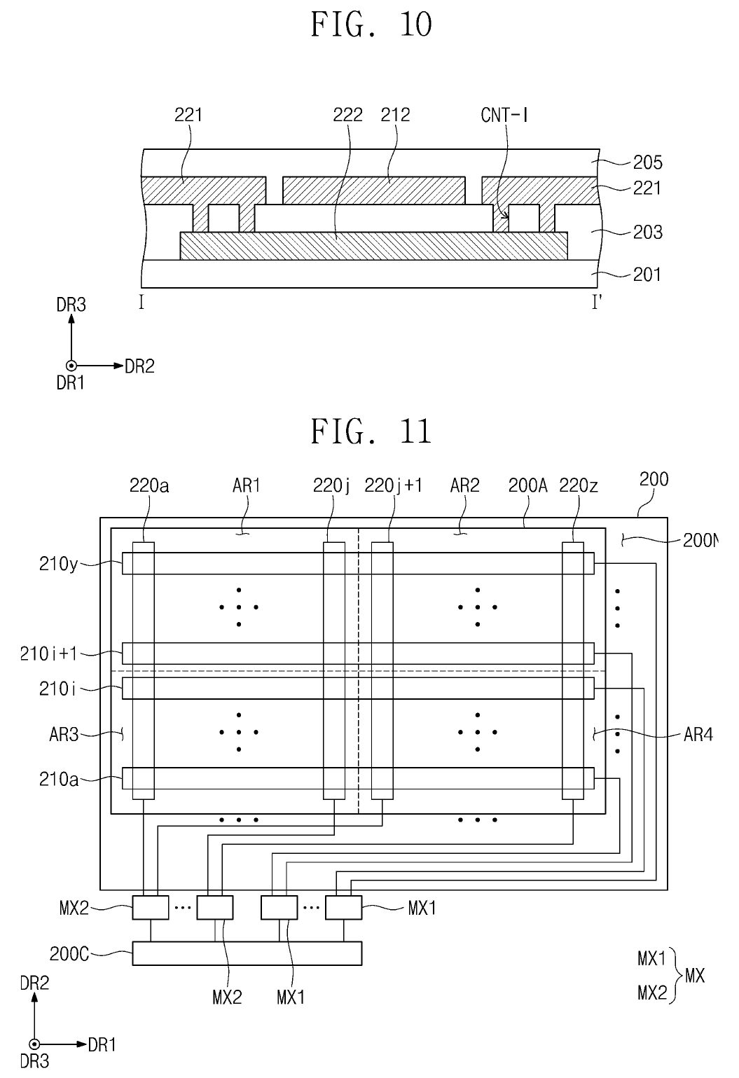

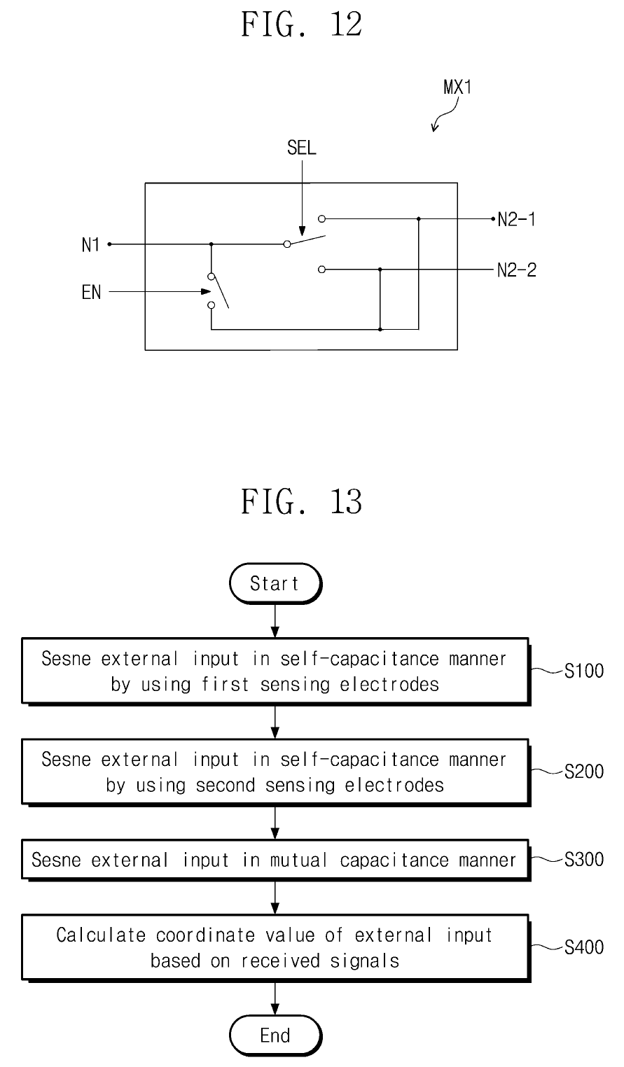

FIG. 11 is a block diagram illustrating a sensor layer and a sensor driver according to an embodiment of the disclosure.

Referring to FIG. 11, the electronic device ED may include the sensor layer 200, a plurality of multiplexers MX, and the sensor driver 200C.

The active area 200A of the sensor layer 200 may include a plurality of areas AR1, AR2, AR3, and AR4. The plurality of areas AR1, AR2, AR3, and AR4 may include a first area AR1, a second area AR2, a third area AR3, and a fourth area AR4.

The second area AR2 may be adjacent to the first area AR1 in the first direction DR1.

The third area AR3 may be adjacent to the first area AR1 in a direction facing away from the second direction DR2. The third area AR3 may be adjacent to the fourth area AR4 in a direction facing away from the first direction DR1.

The fourth area AR4 may be adjacent to the third area AR3 in the first direction DR1. The fourth area AR4 may be adjacent to the second area AR2 in a direction facing away from the second direction DR2.

A plurality of first sensing electrodes 210a to 210i and 210i+1 to 210y and a plurality of second sensing electrodes 220a to 220j and 220j+1 to 220z may be disposed in the active area 200A. The number of first sensing electrodes 210a to 210i and 210i+1 to 210y may be about 50, and the number of second sensing electrodes 220a to 220j and 220j+1 to 220z may be about 80.

The plurality of first sensing electrodes 210a to 210i and 210i+1 to 210y may include a plurality of (1-1)-th sensing electrodes 210a to 210i disposed in the third area AR3 and the fourth area AR4 and a plurality of (1-2)-th sensing electrodes 210i+1 to 210y disposed in the first area AR1 and the second area AR2.

The plurality of second sensing electrodes 220a to 220j and 220j+1 to 220z may include a plurality of (2-1)-th sensing electrodes 220a to 220j disposed in the first area AR1 and the third area AR3 and a plurality of (2-2)-th sensing electrodes 220j+1 to 220z disposed in the second area AR2 and the fourth area AR4.

Each of the plurality of multiplexers MX may be connected between the sensor layer 200 and the sensor driver 200C.

The plurality of multiplexers MX may include a plurality of first multiplexers MX1 and a plurality of second multiplexers MX2.

Each of the plurality of first multiplexers MX1 may be connected to at least two first sensing electrodes among the plurality of first sensing electrodes 210a to 210i and 210i+1 to 210y. One of the at least two first sensing electrodes may be disposed in the third area AR3 and the fourth area AR4, and the other of the at least two first sensing electrodes may be disposed in the first area AR1 and the second area AR2.

Each of the plurality of first multiplexers MX1 may operate to select at least one of the at least two first sensing electrodes so as to be connected to the sensor driver 200C.

Each of the plurality of first multiplexers MX1 may be connected to one of the plurality of (1-1)-th sensing electrodes 210a to 210i and one of the plurality of (1-2)-th sensing electrodes 210i+1 to 210y. For example, one first multiplexer MX1 may be connected to the (1-1)-th sensing electrode 210a and the (1-2)-th sensing electrode 210i+1. Another first multiplexer MX1 may be connected to the (1-1)-th sensing electrode 210i and the (1-2)-th sensing electrode 210y.

Each of the plurality of second multiplexers MX2 may be connected to at least two second sensing electrodes among the plurality of second sensing electrodes 220a to 220j and 220j2 to 220z. One of the at least two second sensing electrodes may be disposed in the first area AR1 and the third area AR3, and the other of the at least two second sensing electrodes may be disposed in the second area AR2 and the fourth area AR4.

Each of the plurality of second multiplexers MX2 may operate to select at least one of the at least two second sensing electrodes so as to be connected to the sensor driver 200C.

Each of the plurality of second multiplexers MX2 may be connected to one of the plurality of (2-1)-th sensing electrodes 220a to 220j and one of the plurality of (2-2)-th sensing electrodes 220j+1 to 220z. For example, one second multiplexer MX2 may be connected to the (2-1)-th sensing electrode 220a and the (2-2)-th sensing electrode 220j+1. Another second multiplexer MX2 may be connected to the (2-1)-th sensing electrode 220j and the (2-2)-th sensing electrode 220z.

According to the disclosure, the number of pads for connecting the sensor layer 200 and the sensor driver 200C may be decreased by the plurality of multiplexers MX. As the number of pads is decreased, the large-area sensor layer 200 may be driven by a small number of sensor drivers 200C. The degree of freedom in design of the electronic device ED (refer to FIG. 3) may be improved. Accordingly, the electronic device ED (refer to FIG. 3) in which the dimensions of the non-display area are reduced may be provided, and the electronic device ED (refer to FIG. 3) with improved reliability may be provided.

FIG. 12 is a circuit diagram of a first multiplexer according to an embodiment of the disclosure.

The first multiplexer MX1 (refer to FIG. 11) is illustrated in FIG. 12 as an example, but the second multiplexer MX2 (refer to FIG. 11) may have substantially the same configuration as the first multiplexer MX1.

Referring to FIGS. 11 and 12, the first multiplexer MX1 may include a first terminal N1 and a plurality of second terminals N2-1 and N2-2.

The first terminal N1 may be connected to the sensor driver 200C.

The plurality of second terminals N2-1 and N2-2 may be respectively connected to at least two first sensing electrodes. The plurality of second terminals N2-1 and N2-2 may include the (2-1)-th terminal N2-1 and the (2-2)-th terminal N2-2.

The (2-1)-th terminal N2-1 may be connected to one of the plurality of (1-1)-th sensing electrodes 210a to 210i. The (2-2)-th terminal N2-2 may be connected to one of the plurality of (1-2)-th sensing electrodes 210i+1 to 210y. For example, the (2-1)-th terminal N2-1 may be connected to the (1-1)-th sensing electrode 210a. The (2-2)-th terminal N2-2 may be connected to the (1-2)-th sensing electrode 210i+1.

The first multiplexer MX1 may receive an enable signal EN and a selection signal SEL.

The enable signal EN may determine the operation of the first multiplexer MX1. When the enable signal EN is “0”, a switch which receives the enable signal EN may be turned on. For example, the first terminal N1 may be connected to the plurality of second terminals N2-1 and N2-2, for example, concurrently or simultaneously.

When the enable signal EN is “1”, a switch which receives the enable signal EN may be turned off. For example, the first terminal N1 may be connected to one of the plurality of second terminals N2-1 and N2-2.

The selection signal SEL may select one of the plurality of second terminals N2-1 and N2-2. When the selection signal SEL is “0”, a switch which receives the selection signal SEL may be disposed such that the first terminal N1 and the (2-1)-th terminal N2-1 are electrically connected to each other.

When the selection signal SEL is “1”, a switch which receives the selection signal SEL may be disposed such that the first terminal N1 and the (2-2)-th terminal N2-2 are connected to each other.

FIG. 13 is a flowchart illustrating an electronic device driving method according to an embodiment of the disclosure.

Referring to FIGS. 4, 8, 11, and 13, when the external input TC is applied to the sensor layer 200, the sensor layer 200 and the sensor driver 200C may calculate the coordinate value I-SS.

The sensor driver 200C may sense the external input TC based on the plurality of first sensing electrodes 210. For example, the operation may be referred to as a “first sensing step”. The sensor driver 200C may sense the external input TC in a self-capacitance manner by using the plurality of first sensing electrodes 210 (S100).

The sensor driver 200C may sense the external input TC based on the plurality of second sensing electrodes 220. For example, the operation may be referred to as a “second sensing step”. The sensor driver 200C may sense the external input TC in the self-capacitance manner by using the plurality of second sensing electrodes 220 (S200).

The sensor driver 200C may sense the external input TC based on the plurality of first sensing electrodes 210 and the plurality of second sensing electrodes 220. For example, the operation may be referred to as a “third sensing step”. The sensor driver 200C may sense the external input TC in a mutual-capacitance manner (S300).

The sensor driver 200C may calculate the coordinate value I-SS of the external input TC based on signals received at the first sensing step, the second sensing step, and the third sensing step (S400).

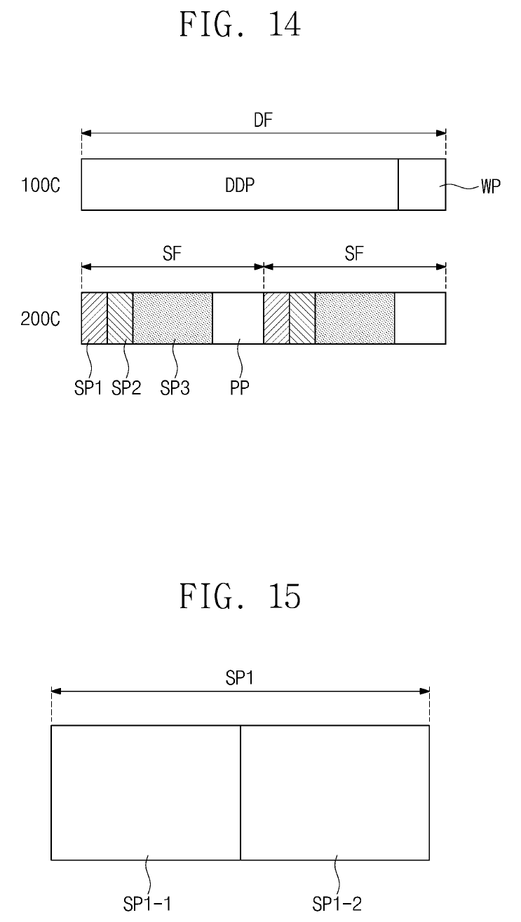

FIG. 14 is a diagram for describing operations of a display driver and a sensor driver according to an embodiment of the disclosure.

Referring to FIGS. 7, 8, 13, and 14, the display driver 100C may drive the display layer 100 in each display frame DF. The display frame DF may be defined as a period from the rising edge of the vertical synchronization signal Vsync to the next rising edge of the vertical synchronization signal Vsync.

The display frame DF may include a display driving period DDP and a wait period WP.

During the display driving period DDP, the display layer 100 may display the image IM (refer to FIG. 3). In the display driving period DDP, pieces of data corresponding to one full image IM (refer to FIG. 3) may be provided to the plurality of pixels PX. During the display driving period DDP, the display driver 100C may provide the data voltages Vdata to the display layer 100.

The wait period WP may be provided after the display driving period DDP. The wait period WP may refer to a period of waiting for the next display frame DF after the image IM (refer to FIG. 3) is provided.

The sensor driver 200C may drive the sensor layer 200 in each sensing frame SF. The sensing frame SF may be synchronized with the driving timing with the display driver 100C based on the vertical synchronization signal Vsync. For example, the display driver 100C and the sensor driver 200C may be referred to as being synchronously driven. For example, during one display frame DF, the sensing frame SF may progress two times. An example in which the display driver 100C and the sensor driver 200C are operates in synchronization is illustrated in FIG. 14. However, this is an example, and the operation of the sensor driver 200C according to an embodiment of the disclosure is not limited thereto. For example, the sensor driver 200C may operate independently of the display driver 100C. For example, the display driver 100C and the sensor driver 200C may be referred to as being asynchronously driven.

The sensing frame SF may include a first sensing period SP1, a second sensing period SP2, a third sensing period SP3, and a processing period PP.

During the first sensing period SP1, the external input TC (refer to FIG. 4) may be sensed based on the plurality of first sensing electrodes 210 (S100).

During the second sensing period SP2, the external input TC (refer to FIG. 4) may be sensed based on the plurality of second sensing electrodes 220 (S200).

During the first sensing period SP1 and the second sensing period SP2, the sensor layer 200 may operate in the self-capacitance manner. Each of the first sensing period SP1 and the second sensing period SP2 may be referred to as a “sub-sensing period”.

During the third sensing period SP3, the external input TC (refer to FIG. 4) may be sensed based on the plurality of first sensing electrodes 210 and the plurality of second sensing electrodes 220 (S300). During the third sensing period SP3, the plurality of first sensing electrodes 210 and the plurality of second sensing electrodes 220 may be capacitively coupled to sense the external input TC (refer to FIG. 4).

In the third sensing period SP3, the sensor driver 200C may output the driving signal TX simultaneously to at least two first sensing electrodes among the plurality of first sensing electrodes 210. The sensor driver 200C may receive the sensing signals RX corresponding to the driving signal TX from at least two second sensing electrodes among the plurality of second sensing electrodes 220.

During the third sensing period SP3, the sensor layer 200 may operate in the mutual-capacitance manner. The third sensing period SP3 may be referred to as a “main sensing period”.

During the processing period PP, the coordinate value I-SS of the external input TC (refer to FIG. 4) may be calculated based on the signals received in the first sensing period SP1, the second sensing period SP2, and the third sensing period SP3 (S400).

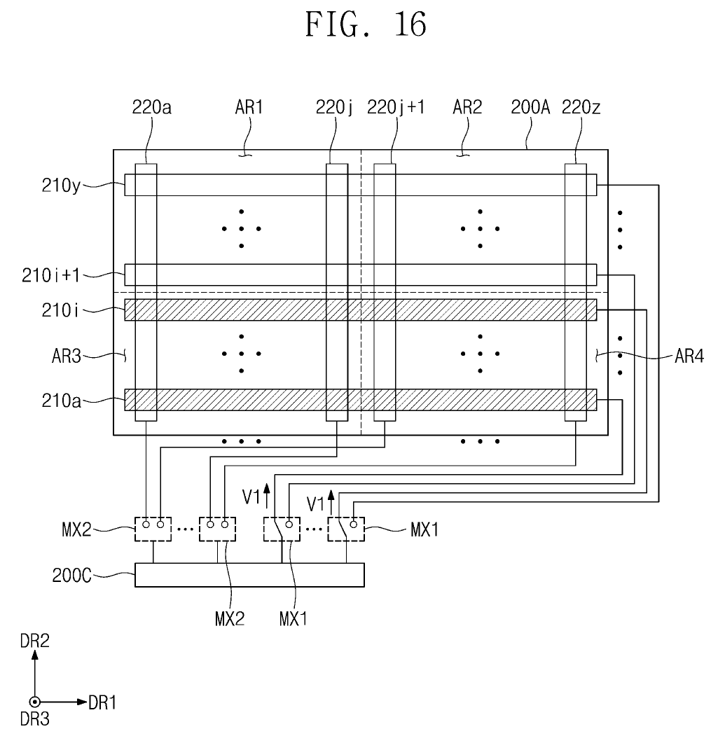

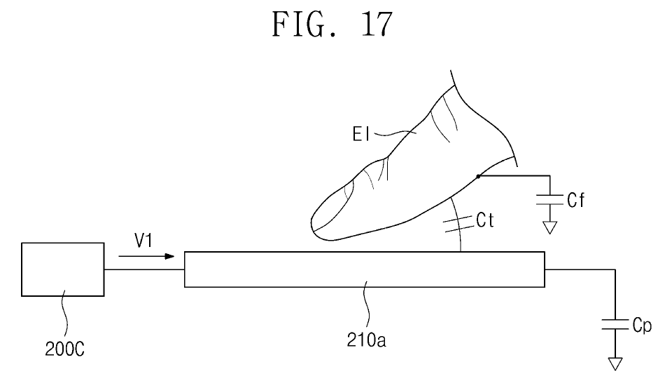

FIG. 15 is a diagram illustrating a first sensing period according to an embodiment of the disclosure, FIG. 16 is a block diagram of a sensor layer and a sensor driver illustrating an operation of a first sensing step according to an embodiment of the disclosure, and FIG. 17 is a diagram for describing a sensor layer and a sensor driver operating in a self-capacitance manner according to an embodiment of the disclosure. In the description of FIG. 16, the components which are described with reference to FIG. 11 are marked by the same reference numerals/signs, and thus, additional description will be omitted to avoid redundancy.

Referring to FIGS. 15, 16, and 17, during the first sensing period SP1, the first terminal N1 (refer to FIG. 12) of the first multiplexer MX1 may be connected to one of the plurality of second terminals N2-1 and N2-2 (refer to FIG. 12) based on the selection signal SEL (refer to FIG. 12).

The first sensing period SP1 may include a first sub-period SP1-1 and a second sub-period SP1-2. The first sub-period SP1-1 and the second sub-period SP1-2 may be continuous with each other.

During the first sub-period SP1-1, the first multiplexers MX1 may be connected to the plurality of (1-1)-th sensing electrodes 210a to 210i disposed in the third area AR3 and the fourth area AR4.

The sensor driver 200C may provide a first voltage V1 to each of the plurality of (1-1)-th sensing electrodes 210a to 210i. The first voltage V1 may have a positive voltage level. The sensor driver 200C may drive the plurality of (1-1)-th sensing electrodes 210a to 210i with the first voltage V1 and may sense the input of the body EI of the user, which is made in the third area AR3 or the fourth area AR4.

The body EI of the user may form a capacitance Cf with a ground. The (1-1)-th sensing electrode 210a may form a capacitance Cp with the ground.

An additional capacitance Ct may be formed on the (1-1)-th sensing electrode 210a by the body EI of the user. For example, a total capacitance may be increased.

The sensor driver 200C may provide the first voltage V1 to the (1-1)-th sensing electrode 210a. The sensor driver 200C may sense the body EI of the user by using a change in the capacitance Ct between the (1-1)-th sensing electrode 210a and the body EI of the user.

The operation of the (1-1)-th sensing electrode 210a is described in FIG. 17 as an example, but the remaining first sensing electrodes 210 and the plurality of second sensing electrodes 220 which operate in the self-capacitance manner may operate in the same manner as the (1-1)-th sensing electrode 210a.

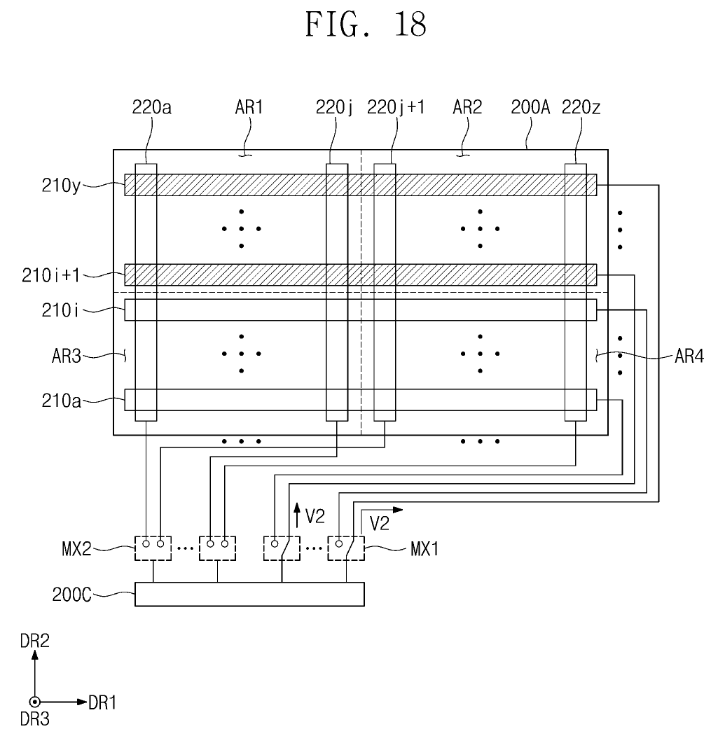

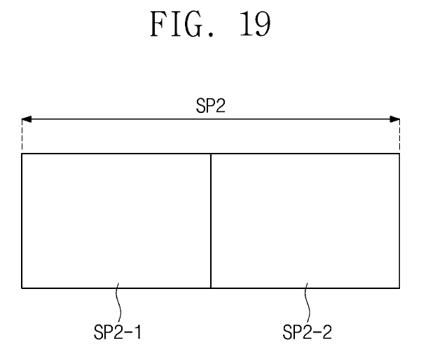

FIG. 18 is a block diagram of a sensor layer and a sensor driver illustrating an operation of a first sensing step according to an embodiment of the disclosure. In the description of FIG. 18, the components which are described with reference to FIG. 11 are marked by the same reference numerals/signs, and thus, additional description will be omitted to avoid redundancy.

Referring to FIGS. 15 and 18, during the second sub-period SP1-2, the first multiplexers MX1 may be connected to the plurality of (1-2)-th sensing electrodes 210i+1 to 210y disposed in the first area AR1 and the second area AR2.

The sensor driver 200C may provide a second voltage V2 to each of the plurality of (1-2)-th sensing electrodes 210i+1 to 210y. The second voltage V2 may be different in voltage level from the first voltage V1 (refer to FIG. 16). For example, the second voltage V2 may have a negative voltage level. Signs of the first voltage V1 (refer to FIG. 16) and the second voltage V2 may be different from each other.

The sensor driver 200C may drive the plurality of (1-2)-th sensing electrodes 210i+1 to 210y with the second voltage V2 and may sense the input of the body EI (refer to FIG. 17) of the user, which is made in the first area AR1 or the second area AR2.

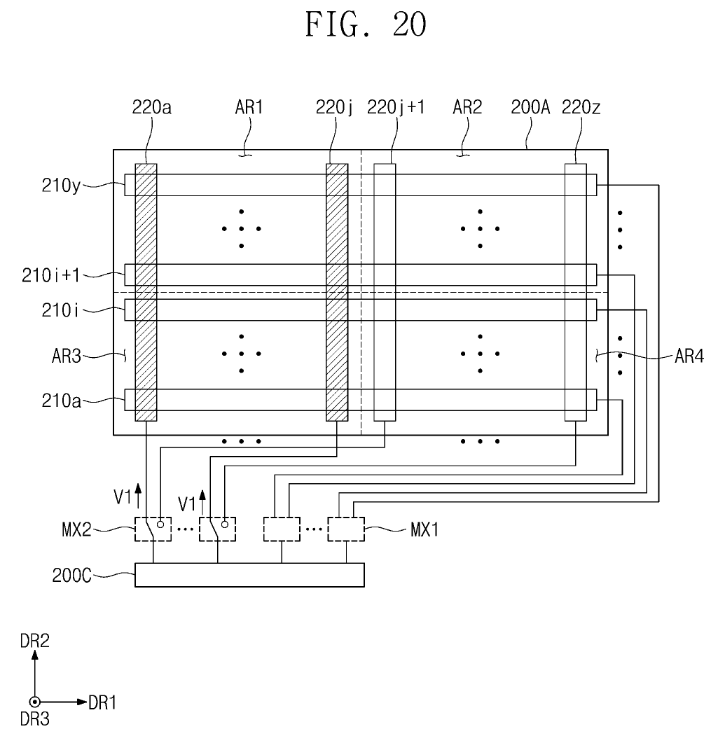

FIG. 19 is a diagram illustrating a second sensing period according to an embodiment of the disclosure, and FIG. 20 is a block diagram of a sensor layer and a sensor driver illustrating an operation of a second sensing step according to an embodiment of the disclosure. In the description of FIG. 20, the components which are described with reference to FIG. 11 are marked by the same reference numerals/signs, and thus, additional description will be omitted to avoid redundancy.

Referring to FIGS. 19 and 20, during the second sensing period SP2, the second multiplexer MX2 may be connected to one of the plurality of second terminals N2-1 and N2-2 (refer to FIG. 12) based on the selection signal SEL (refer to FIG. 12).

The second sensing period SP2 may include a third sub-period SP2-1 and a fourth sub-period SP2-2. The third sub-period SP2-1 and the fourth sub-period SP2-2 may be continuous with each other.

During the third sub-period SP2-1, the second multiplexers MX2 may be connected to the plurality of (2-1)-th sensing electrodes 220a to 220j disposed in the first area AR1 and the third area AR3.

The sensor driver 200C may provide the first voltage V1 to each of the plurality of (2-1)-th sensing electrodes 220a to 220j. The sensor driver 200C may drive the plurality of (2-1)-th sensing electrodes 220a to 220j with the first voltage V1 and may sense the input of the body EI (refer to FIG. 17) of the user, which is made in the first area AR1 or the third area AR3.

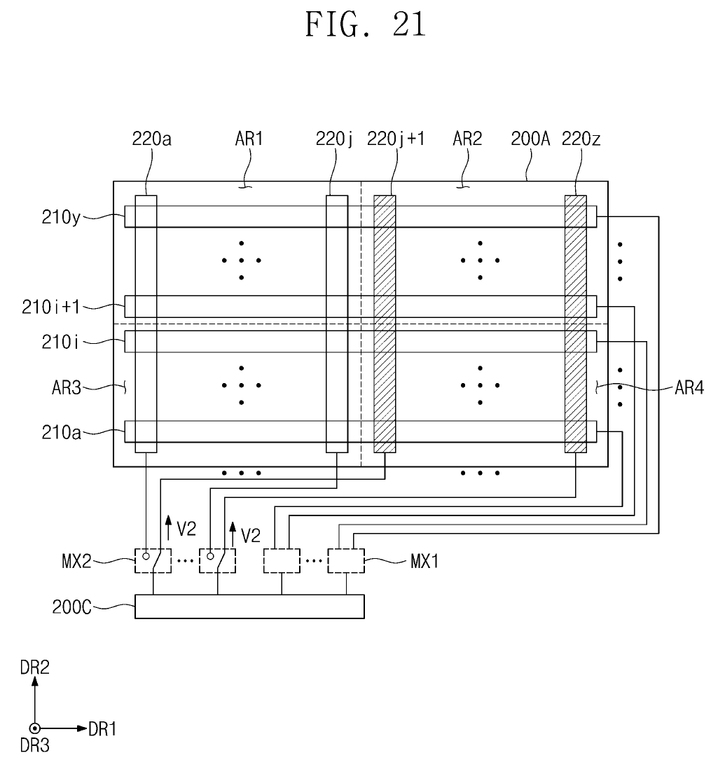

FIG. 21 is a block diagram of a sensor layer and a sensor driver illustrating an operation of a second sensing step according to an embodiment of the disclosure. In the description of FIG. 21, the components which are described with reference to FIG. 11 are marked by the same reference numerals/signs, and thus, additional description will be omitted to avoid redundancy.

Referring to FIGS. 19 and 21, during the fourth sub-period SP2-2, the second multiplexers MX2 may be connected to the plurality of (2-2)-th sensing electrodes 220j+1 to 220z disposed in the second area AR2 and the fourth area AR4.

The sensor driver 200C may provide the second voltage V2 to each of the plurality of (2-2)-th sensing electrodes 220j+1 to 220z. The sensor driver 200C may drive the plurality of (2-2)-th sensing electrodes 220j+1 to 220z with the second voltage V2 and may sense the input of the body EI (refer to FIG. 17) of the user, which is made in the second area AR2 or the fourth area AR4.

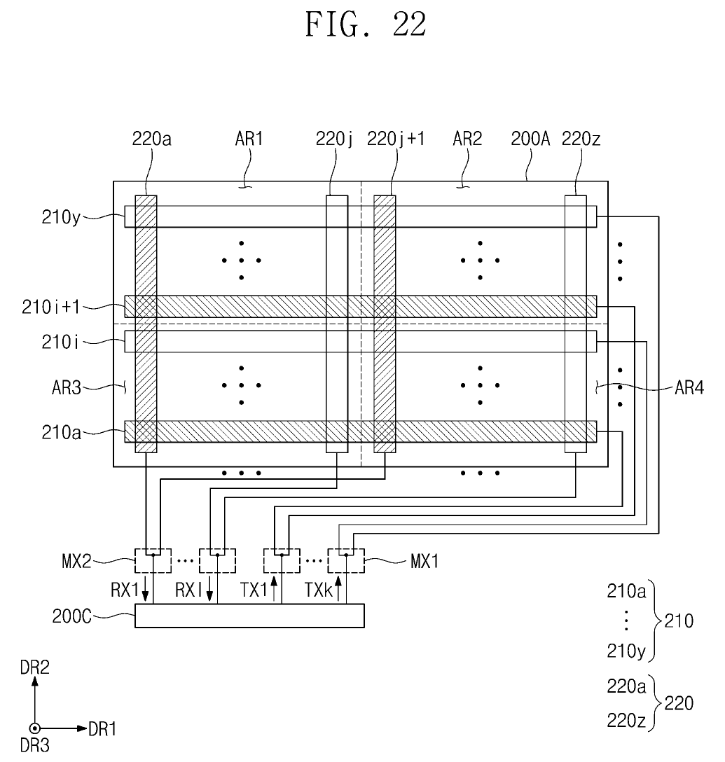

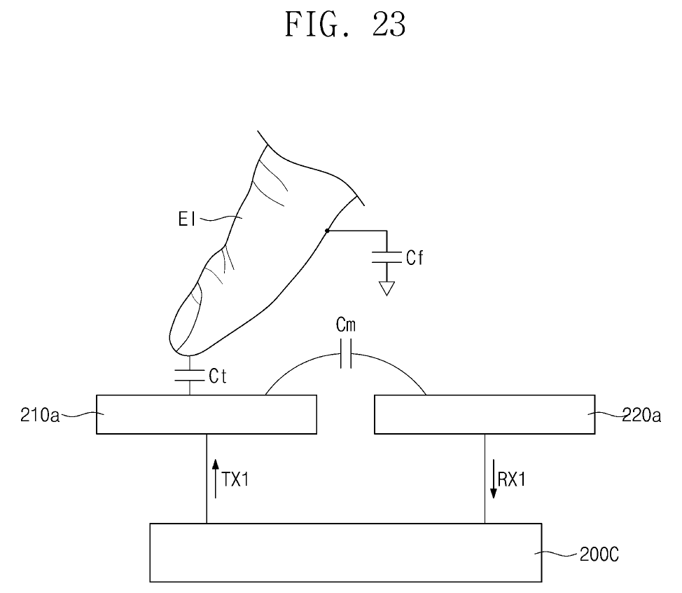

FIG. 22 is a block diagram of a sensor layer and a sensor driver illustrating an operation of a third sensing step according to an embodiment of the disclosure, and FIG. 23 is a diagram for describing a sensor layer and a sensor driver operating in a mutual-capacitance manner according to an embodiment of the disclosure. In the description of FIG. 22, the components which are described with reference to FIG. 11 are marked by the same reference numerals/signs, and thus, additional description will be omitted to avoid redundancy.

Referring to FIGS. 14, 22, and 23, during the third sensing period SP3, the first terminal N1 (refer to FIG. 12) of the first multiplexer MX1 may be connected to all the second terminals N2-1 and N2-2 (refer to FIG. 12) based on the enable signal EN (refer to FIG. 12).

The sensor driver 200C may provide a plurality of driving signals TX1 to TXk to the plurality of first sensing electrodes 210. For example, “k” may be half the number of first sensing electrodes 210.

The sensor driver 200C may output a driving signal simultaneously to at least two first sensing electrodes among the plurality of first sensing electrodes 210. For example, the sensor driver 200C may provide the driving signal TX1 simultaneously to the (1-1)-th sensing electrode 210a and the (1-2)-th sensing electrode 210i+1. The sensor driver 200C may sequentially provide the plurality of driving signals TX1 to TXk. Finally, the sensor driver 200C may provide the driving signal TXk simultaneously to the (1-1)-th sensing electrode 210i and the (1-2)-th sensing electrode 210y. However, this is an example, and the order of driving the plurality of first sensing electrodes 210 according to an embodiment of the disclosure is not limited thereto.

The sensor driver 200C may receive a plurality of sensing signals RX1 to RXI from the plurality of second sensing electrodes 220. For example, “I” may be half the number of second sensing electrodes 220.

The sensor driver 200C may receive a sensing signal corresponding to the driving signal from two second sensing electrodes electrically connected to each other from among the plurality of second sensing electrodes 220. For example, while the plurality of driving signals TX1 to TXk are provided, the sensor driver 200C may receive the sensing signal RX1 from the (2-1)-th sensing electrode 220a and the (2-2)-th sensing electrode 220j+1. The sensor driver 200C may sequentially receive the plurality of sensing signals RX1 to RXI. Finally, while the plurality of driving signals TX1 to TXk are provided, the sensor driver 200C may receive the sensing signal RXI from the (2-1)-th sensing electrode 220j and the (2-2)-th sensing electrode 220z.

The body EI of the user may form the capacitance Cf with the ground.

The capacitance Ct may be formed on the (1-1)-th sensing electrode 210a by the body EI of the user. The charge leakage may be occurred by the body EI of the user. For example, a portion of the electric field formed on the (1-1)-th sensing electrode 210a may flow to the body EI of the user through the capacitance Ct.

A mutual capacitance Cm may be formed between the (1-1)-th sensing electrode 210a and the (2-1)-th sensing electrode 220a. When the body EI of the user is provided, the magnitude of the mutual capacitance Cm may be reduced by the charge leakage.

The sensor driver 200C may provide the driving signal TX1 to the (1-1)-th sensing electrode 210a. The sensor driver 200C may receive the sensing signal RX1 from the (2-1)-th sensing electrode 220a. The sensor driver 200C may sense the body EI of the user by using a change in the mutual capacitance Cm between the (1-1)-th sensing electrode 210a and the (2-1)-th sensing electrode 220a.

The operation between a pair of the (1-1)-th sensing electrode 210a and the (2-1)-th sensing electrode 220a is described in FIG. 23 as an example, but the remaining first sensing electrodes 210 and the remaining second sensing electrodes 220 which operate in the mutual-capacitance manner may operate in the same manner as the (1-1)-th sensing electrode 210a and the (2-1)-th sensing electrode 220a.

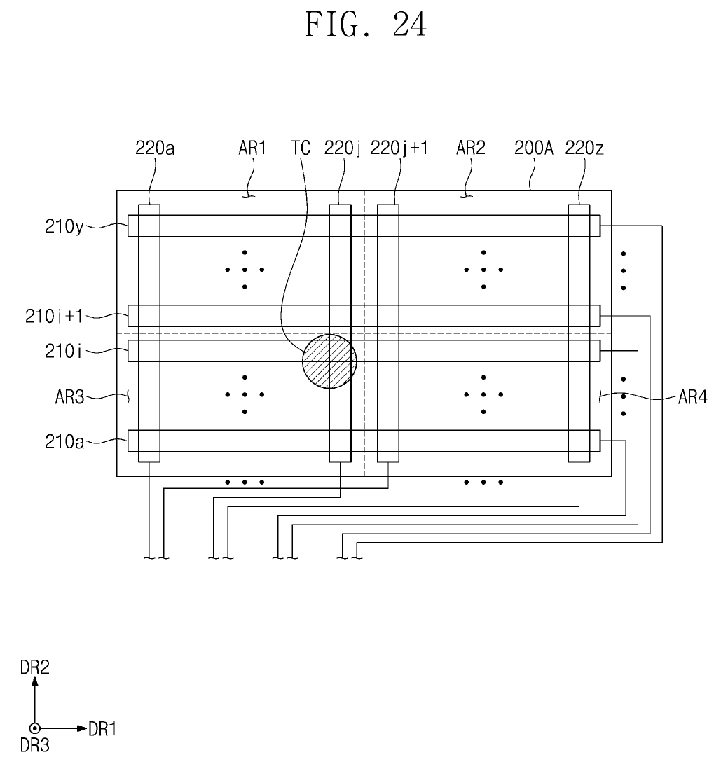

FIG. 24 is a block diagram of a sensor layer illustrating an operation of a processing period according to an embodiment of the disclosure.

Referring to FIGS. 11-24 the external input TC may be provided in the third area AR3.

During the first sensing period SP1, the sensor driver 200C may sense the external input TC in the self-capacitance manner by using the plurality of first sensing electrodes 210 (S100).

In the first sub-period SP1-1, the sensor driver 200C may drive the plurality of (1-1)-th sensing electrodes 210a to 210i with the first voltage V1 and may perform the sensing operation. For example, the sensor driver 200C may sense that the external input TC exists at the (1-1)-th sensing electrode 210i.

During the second sensing period SP2, the sensor driver 200C may sense the external input TC in the self-capacitance manner by using the plurality of second sensing electrodes 220 (S200).

In the third sub-period SP2-1, the sensor driver 200C may drive the plurality of (2-1)-th sensing electrodes 220a to 220j with the first voltage V1 and may perform the sensing operation. For example, the sensor driver 200C may sense that the external input TC exists at the (2-1)-th sensing electrode 220j.

During the third sensing period SP3, the sensor driver 200C may sense the external input TC in the mutual-capacitance manner (S300). The sensor driver 200C may simultaneously drive and sense a plurality of sensing channels by the first multiplexers MX1 and the second multiplexers MX2. For example, the sensor driver 200C may provide the driving signal TXk simultaneously to the (1-1)-th sensing electrode 210i and the (1-2)-th sensing electrode 210y. The sensor driver 200C may receive the sensing signal RXI from the (2-1)-th sensing electrode 220j and the (2-2)-th sensing electrode 220z.

According to the method of simultaneously driving and sensing a plurality of sensing channels, the sensor driver 200C may sense that the external input TC exists, based on the sensing signal RXI, in each of the plurality of areas AR1, AR2, AR3, and AR4. For example, the sensor driver 200C may calculate first coordinates, second coordinates, third coordinates, and fourth coordinates. The first coordinates may be defined as an area where the (1-2)-th sensing electrode 210y and the (2-1)-th sensing electrode 220j in the first area AR1 intersect each other. The second coordinates may be defined as an area where the (1-2)-th sensing electrode 210y and the (2-2)-th sensing electrode 220z in the second area AR2 intersect each other. The third coordinates may be defined as an area where the (1-1)-th sensing electrode 210i and the (2-1)-th sensing electrode 220j intersect each other. The fourth coordinates may be defined as an area where the (1-1)-th sensing electrode 210i and the (2-2)-th sensing electrode 220z intersect each other.

During the processing period PP, the coordinate value I-SS of the external input TC may be calculated based on the signals sensed in the first sensing period SP1 to the third sensing period SP3 (S400).

In the first sensing period SP1, the sensor driver 200C may sense that the external input TC exists at the (1-1)-th sensing electrode 210i.

In the second sensing period SP2, the sensor driver 200C may sense that the external input TC exists at the (2-1)-th sensing electrode 220j.

In the third sensing period SP3, the sensor driver 200C may sense that the external input TC exists at at least one of the first coordinates, the second coordinates, the third coordinates, and the fourth coordinates.

The sensor driver 200C may calculate the third coordinates as the coordinate value I-SS by combining the signals sensed in the first sensing period SP1 to the third sensing period SP3.

In the first sensing period SP1 and the second sensing period SP2, the coordinates in the first, second, third, and fourth areas AR1, AR2, AR3, and AR4 may be distinguished by the operations of the first multiplexer MX1 and the second multiplexer MX2.

When the external input TC is disposed in the first area AR1, signals received from the plurality of first sensing electrodes 210 may have a negative voltage level based on the second voltage V2, and signals received from the plurality of second sensing electrodes 220 may have a positive voltage level based on the first voltage V1.

When the external input TC is disposed in the second area AR2, signals received from the plurality of first sensing electrodes 210 may have a negative voltage level based on the second voltage V2, and signals received from the plurality of second sensing electrodes 220 may have a negative voltage level based on the second voltage V2.

When the external input TC is disposed in the third area AR3, signals received from the plurality of first sensing electrodes 210 may have a positive voltage level based on the first voltage V1, and signals received from the plurality of second sensing electrodes 220 may have a positive voltage level based on the first voltage V1.

When the external input TC is disposed in the fourth area AR4, signals received from the plurality of first sensing electrodes 210 may have a positive voltage level based on the first voltage V1, and signals received from the plurality of second sensing electrodes 220 may have a negative voltage level based on the second voltage V2.

According to an embodiment, even though it is impossible to identify coordinates in the third sensing period SP3 due to the driving of the multiplexers MX1 and MX2, during the first sensing period SP1 and the second sensing period SP2, the sensor driver 200C may identify the external input TC based on voltage signs of the first, second, third, and fourth areas AR1, AR2, AR3, and AR4 of the active area 200A. For example, a multi-touch may be sensed by the method of driving the electronic device ED (refer to FIG. 3). The sensor driver 200C may calculate the coordinate value I-SS by using the first sensing period SP1, the second sensing period SP2, and the third sensing period SP3. Accordingly, the electronic device ED (refer to FIG. 3) whose reliability is improved may be provided.

Unlike the disclosure, when the driving signals TX are respectively provided by the multiplexer MX1 or MX2 without being provided to at least two first sensing electrodes at the same time, the plurality of first sensing electrodes 210 may be sequentially driven independently of each other, thereby increasing the length of the third sensing period SP3. However, according to an embodiment, in the third sensing period SP3, the sensor driver 200C may output the driving signal TX simultaneously to at least two first sensing electrodes among the plurality of first sensing electrodes 210. As the driving time in the third sensing period SP3 is shortened, the report rate of the sensor driver 200C may be increased. Accordingly, the electronic device ED (refer to FIG. 3) whose reliability is improved may be provided.

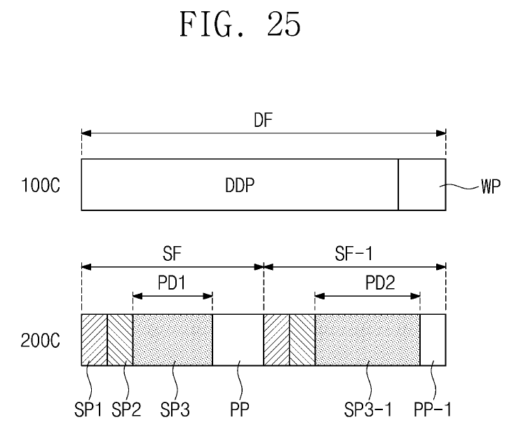

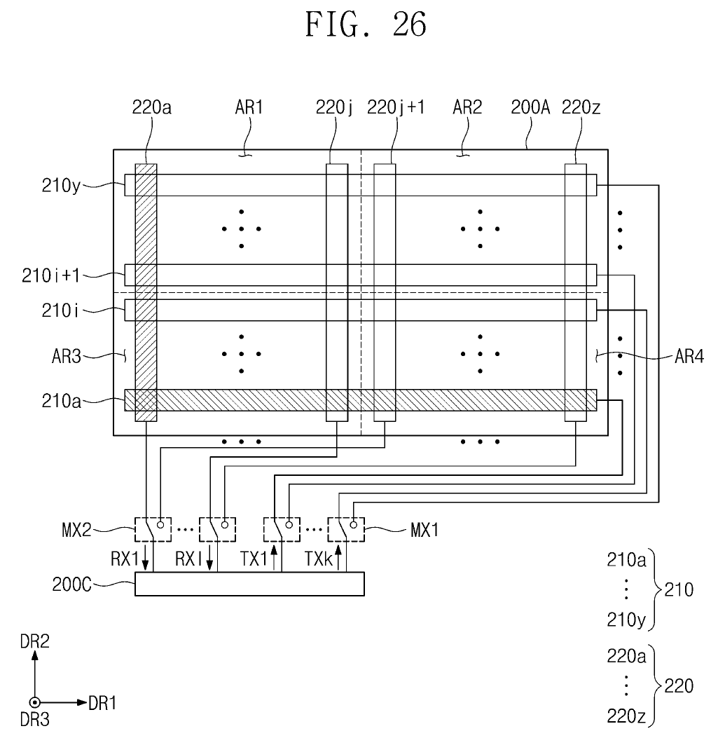

FIG. 25 is a diagram for describing a display driver and a sensor driver according to an embodiment of the disclosure, and FIG. 26 is a block diagram of a sensor layer and a sensor driver illustrating an operation of a third sensing step according to an embodiment of the disclosure. In the description of FIG. 25, the components which are described with reference to FIG. 14 are marked by the same reference numerals/signs, and thus, additional description will be omitted to avoid redundancy. In the description of FIG. 26, the components which are described with reference to FIG. 22 are marked by the same reference numerals/signs, and thus, additional description will be omitted to avoid redundancy.

Referring to FIGS. 11, 25, and 26, the sensor driver 200C may drive the sensor layer 200 in each sensing frame SF or SF-1. The sensing frame SF or SF-1 may include the first sensing frame SF and the second sensing frame SF-1. The length of the first sensing frame SF may be substantially the same as the length of the second sensing frame SF-1.

The second sensing frame SF-1 may include the first sensing period SP1, the second sensing period SP2, a fourth sensing period SP3-1, and a processing period PP-1.

A length PD2 of the fourth sensing period SP3-1 may be longer than a length PD1 of the third sensing period SP3 in the first sensing frame SF.

During the fourth sensing period SP3-1, the external input TC (refer to FIG. 4) may be sensed based on the plurality of first sensing electrodes 210 and the plurality of second sensing electrodes 220.

In the fourth sensing period SP3-1, the sensor driver 200C may output the driving signals TX1 to TXk to the plurality of first sensing electrodes 210, respectively. The sensor driver 200C may receive the sensing signals RX1 to RXI corresponding to the driving signals TX1 to TXk from the plurality of second sensing electrodes 220.

During the fourth sensing period SP3-1, the first terminal N1 (refer to FIG. 12) of each of the first multiplexer MX1 and the second multiplexer MX2 may be connected to one of the second terminals N2-1 and N2-2 (refer to FIG. 12) based on the select signal SEL (refer to FIG. 12).

The first terminal N1 (refer to FIG. 12) of the first multiplexer MX1 may be connected to the (2-1)-th terminal N2-1 (refer to FIG. 12), and the sensor driver 200C may sequentially provide the driving signals TX1 to TXk to the plurality of (1-1)-th sensing electrodes 210a to 210i, respectively. Afterwards, the first terminal N1 (refer to FIG. 12) of the first multiplexer MX1 may be connected to the (2-2)-th terminal N2-2 (refer to FIG. 12), and the sensor driver 200C may sequentially provide the driving signals TX1 to TXk to the plurality of (1-2)-th sensing electrodes 210i+1 to 210y, respectively. For example, the sensor driver 200C may sequentially provide the driving signals TX1 to TXk to the plurality of first sensing electrodes 210.

The first terminal N1 (refer to FIG. 12) of the second multiplexer MX2 may be connected to the (2-1)-th terminal N2-1 (refer to FIG. 12), and the sensor driver 200C may sequentially receive the sensing signals RX1 to RXI from the plurality of (2-1)-th sensing electrodes 220a to 220j. Afterwards, the first terminal N1 (refer to FIG. 12) of the second multiplexer MX2 may be connected to the (2-2)-th terminal N2-2 (refer to FIG. 12), and the sensor driver 200C may sequentially receive the sensing signals RX1 to RXI from the plurality of (2-2)-th sensing electrodes 220j+1 to 220z, respectively. For example, the sensor driver 200C may receive the sensing signals RX1 to RXI from the plurality of second sensing electrodes 220.

During the processing period PP-1, the coordinate value I-SS of the external input TC (refer to FIG. 4) may be calculated based on the signals received in the first sensing period SP1, the second sensing period SP2, and the fourth sensing period SP3-1.

According to an embodiment, during the fourth sensing period SP3-1, the sensor layer 200 may operate in a general mutual-capacitance manner. The sensor driver 200C may identify coordinates in the first, second, third, and fourth areas AR1, AR2, AR3, and AR4 based on the signals received in the fourth sensing period SP3-1. A multi-touch may be sensed by the method of driving the electronic device ED (refer to FIG. 3). The sensor driver 200C may calculate the coordinate value I-SS by using the first sensing period SP1, the second sensing period SP2, and the fourth sensing period SP3-1. Accordingly, the electronic device ED (refer to FIG. 3) whose reliability is improved may be provided.

According to an embodiment, the sensor driver 200C may operate based on the first sensing frame SF and the second sensing frame SF-1 and may calculate the coordinate value I-SS based on the signals received in each of the first sensing frame SF and the second sensing frame SF-1. Accordingly, the electronic device ED (refer to FIG. 3) whose reliability is improved may be provided.

According to the above description, the number of pads for connecting a sensor layer and a sensor driver may be reduced by a multiplexer. Because the number of pads is reduced, the large-area sensor layer may be driven with a small number of sensor drivers. The degree of freedom in design of an electronic device may be improved. Accordingly, an electronic device in which the dimensions of a non-display area are reduced may be provided, and an electronic device with improved reliability may be provided.

According to the above description, even though it is impossible to identify coordinates in a third sensing period due to driving of the multiplexer, during a first sensing period and a second sensing period, the sensor driver may identify an external input based on voltage signs of first to fourth areas of an active area. For example, a multi-touch may be sensed by an electronic device driving method. The sensor driver may calculate a coordinate value by using the first sensing period, the second sensing period, and the third sensing period. Accordingly, an electronic device with improved reliability may be provided.

At least one of the components, elements, modules, units, or the like (collectively "components" in this paragraph) represented by a block or an equivalent indication (collectively “block”) in the above embodiments including the drawings, for example, FIGS. 1, 4, 7, 8, 11 and 16-18, may be physically implemented by analog and/or digital circuits including one or more of a logic gate, an integrated circuit, a microprocessor, a microcontroller, a memory circuit, a passive electronic component, an active electronic component, an optical component, and the like, and may be driven by software and/or firmware implemented by computer instruction codes stored in one or more internal or external memories to perform the functions or operations described herein. These components may, for example, be embodied in one or more semiconductor chips, or on substrate supports such as printed circuit boards and the like. These circuits may also be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks. Likewise, the blocks of the embodiments may be physically combined into more complex blocks.

While the disclosure has been described with reference to embodiments thereof, it will be apparent to those of ordinary skill in the art that various changes and modifications may be made thereto without departing from the spirit and scope of the disclosure as set forth in the following claims.

What is claimed is:

1. An electronic device comprising:
a display layer;
a sensor layer on the display layer and comprising a plurality of sensing electrodes in an active area;
a sensor driver configured to drive the sensor layer in each sensing frame; and
a multiplexer connected between the sensor layer and the sensor driver,
wherein the plurality of sensing electrodes comprise:
a plurality of first sensing electrodes each extending in a first direction; and
a plurality of second sensing electrodes each extending in a second direction intersecting the first direction,
wherein the multiplexer comprises:
a first multiplexer connected to at least two first sensing electrodes among the plurality of first sensing electrodes; and
a second multiplexer connected to at least two second sensing electrodes among the plurality of second sensing electrodes, and
wherein the sensor driver is configured to provide a driving signal simultaneously to the at least two first sensing electrodes.

2. The electronic device of claim 1, wherein the sensing frame comprises:
a first sensing period in which an external input is sensed based on the plurality of first sensing electrodes;
a second sensing period in which the external input is sensed based on the plurality of second sensing electrodes; and
a third sensing period in which the driving signal is output.

3. The electronic device of claim 2, wherein the sensor layer is configured to operate in a self-capacitance manner in the first sensing period and the second sensing period, and
wherein the sensor layer is configured to operate in a mutual-capacitance manner in the third sensing period.

4. The electronic device of claim 2, wherein, in the third sensing period, the sensor driver is configured to receive a sensing signal corresponding to the driving signal from the at least two second sensing electrodes.

5. The electronic device of claim 2, wherein the active area comprises:
a first area;
a second area adjacent to the first area in the first direction;
a third area adjacent to the first area in the second direction; and
a fourth area adjacent to the third area in the first direction,
wherein a first one of the at least two first sensing electrodes is in the third area and the fourth area, and
wherein a second one of the at least two first sensing electrodes is in the first area and the second area.

6. The electronic device of claim 5, wherein the first sensing period comprises a first sub-period and a second sub-period, and
wherein, in the first sub-period, the sensor driver is configured to provide a first voltage having a positive voltage level to the first one of the at least two first sensing electrodes in the third area and the fourth area.

7. The electronic device of claim 6, wherein, in the second sub-period, the sensor driver is configured to provide a second voltage having a negative voltage level to the second one of the at least two first sensing electrodes in the first area and the second area.

8. The electronic device of claim 7, wherein a first one of the at least two second sensing electrodes is in the first area and the third area,
wherein the second sensing period comprises a third sub-period and a fourth sub-period, and
wherein, in the third sub-period, the sensor driver is configured to provide the first voltage to the first one of the at least two second sensing electrodes in the first area and the third area.

9. The electronic device of claim 8, wherein a second one of the at least two second sensing electrodes is in the second area and the fourth area, and
wherein, in the fourth sub-period, the sensor driver is configured to provide the second voltage to the second one of the at least two second sensing electrodes in the second area and the fourth area.

10. The electronic device of claim 8, wherein the first multiplexer comprises:
a first terminal connected to the sensor driver; and
a plurality of second terminals connected to the at least two first sensing electrodes, respectively, and
wherein the first multiplexer is configured to receive an enable signal and a selection signal.

11. The electronic device of claim 10, wherein, in the first sensing period, the first terminal is connected to one of the plurality of second terminals based on the selection signal.

12. The electronic device of claim 10, wherein, in the third sensing period, the first terminal is concurrently connected to the plurality of second terminals based on the enable signal.

13. The electronic device of claim 10, wherein the sensing frame further comprises a fourth sensing period in which the sensor layer operates in a mutual-capacitance manner.

14. The electronic device of claim 13, wherein, in the fourth sensing period, the first terminal is connected to one of the plurality of second terminals based on the selection signal.

15. A method of sensing an external input, the method comprising:
a first sensing step of sensing the external input based on a plurality of first sensing electrodes of a sensor layer;
a second sensing step of sensing the external input based on a plurality of second sensing electrodes intersecting the plurality of first sensing electrodes of the sensor layer; and
a third sensing step of sensing the external input based on the plurality of first sensing electrodes and the plurality of second sensing electrodes of the sensor layer,
wherein the third sensing step comprises:
providing a driving signal simultaneously to at least two first sensing electrodes among the plurality of first sensing electrodes by a sensor driver configured to drive the plurality of first sensing electrodes and the plurality of second sensing electrodes; and
receiving a sensing signal corresponding to the driving signal from at least two second sensing electrodes among the plurality of second sensing electrodes electrically connected.

16. The method of claim 15, wherein an active area of the sensor layer comprises:
a first area;
a second area adjacent to the first area in a first direction;
a third area adjacent to the first area in a second direction intersecting the first direction; and
a fourth area adjacent to the third area in the first direction, and
wherein the first sensing step comprises providing a first voltage having a positive voltage level to a first one of the at least two first sensing electrodes in the third area and the fourth area.

17. The method of claim 16, wherein the first sensing step further comprises providing a second voltage having a negative voltage level to a second one of the at least two first sensing electrodes in the first area and the second area.

18. The method of claim 17, wherein the second sensing step comprises providing the first voltage to a first one of the at least two second sensing electrodes in the first area and the third area.

19. The method of claim 18, wherein the second sensing step further comprises providing the second voltage to a second one of the at least two second sensing electrodes in the second area and the fourth area, and
wherein the method further comprises calculating a coordinate value of the external input based on signals received in the first sensing step, the second sensing step, and the third sensing step.

20. An electronic apparatus comprising:
a display layer configured to display an image;
a sensor layer on the display layer and comprising a plurality of sensing electrodes; and
a sensor driver configured to supply a driving signal to the sensor layer and to receive a corresponding sensing signal,
wherein the sensor layer is configured to:
operate in a self-capacitance mode in first and second sensing periods,
operate in a mutual-capacitance mode in a third sensing period, and
determine a coordinate value of an external input based on sensing signals received in the first, second, and third sensing periods.
